(19) United States
(12) Patent Application Publication
(10) Pub. No.: US 2026/0065087 A1
(43) Pub. Date: Mar. 5, 2026

(54) SYSTEMS AND METHODS FOR PREDICTING PERFORMANCE OF LARGE LANGUAGE MODELS (LLMS)

(71) Applicant: Accenture Global Solution Limited, Dublin (IE)

(72) Inventors: Raghunandan KHAMITKAR, Bangalore (IN); Sarang Padmakar Joshi, Pune (IN); Vijaya Kumar M.K, Bangalore (IN); Anand Yegati Vasudeva Rao, Bangalore (IN); Hemant Chandrakant Patil, Pune (IN); Dibyendu Saha, Bangalore (IN)

(73) Assignee: Accenture Global Solution Limited, Dublin (IE)

(21) Appl. No.: 19/287,695

(22) Filed: Jul. 31, 2025

(30) Foreign Application Priority Data
Aug. 29, 2024 (IN) 202441065277

(51) Int. Cl. G06N 5/022

(52) U.S. Cl. CPC G06N 5/022

(57) ABSTRACT

Systems and methods for predicting performance of Large Language Models (LLMS) are disclosed. The system receives a performance data associated with at least one Large Language Model (LLM) from a plurality of data sources. The system extracts a plurality of features related to model performance from the received performance data. The system selects an appropriate Artificial Intelligence (AI)-based prediction model from among a plurality of Artificial Intelligence (AI)-based prediction models based on the extracted plurality of features. The system applies extracted plurality of features and the received performance data to selected appropriate Artificial Intelligence (AI)-based prediction model. The system predicts a performance of the at least one LLM based on results of the appropriate Artificial Intelligence (AI)-based prediction model. The system validates the predicted performance of the at least one LLM with actual performance metrics. The system determines at least one issue in model performance based on results of validation.

### PRIORITY

This application claims foreign priority to INDIA Application Serial Number 202441065277, filed Aug. 29, 2024, entitled “Systems and Methods for Predicting Performance of Large Language Models (LLMS)”, the disclosures of which are hereby incorporated by reference in their entireties.

### TECHNICAL FIELD

The present disclosure generally relates to Artificial Intelligence (AI)-based systems and, more specifically, relates to a systems and methods for predicting performance of Large Language Models (LLMs).

### BACKGROUND

Generally, a Generative Artificial Intelligence (Gen AI) may refer to a type of Artificial Intelligence (AI) focused on creating or generating new content or data, including text, images, music, and videos that exhibit human-like creativity and originality. Such Gen AI may automate and optimize tasks that were previously manual and time-consuming, such as content creation, data analysis, and coding, thereby enhancing productivity and driving significant innovations across various sectors.

As Gen AI continues to evolve, the Gen AI may redefine methods of delivery in Technology Delivery Life Cycle (TDLC) to further improve productivity. Therefore, it becomes crucial to understand legal and security considerations, delivery execution essentials, and prepare to embrace the new approaches to Gen AI delivery.

Large Language Models (LLMs), refer to a type of Artificial Intelligence (AI) designed to understand, generate, and work with human language, play a key role in creating new content. There may considerable momentum in developing Gen AI-based solutions, particularly in application development, which also requires training LLMs with appropriately sized and voluminous data sets to fully realize their potential benefits.

Generally, developers deploy Artificial Intelligence (AI) based models, such as for example, a Large Language Model (LLM) into a production environment tailored to some specific software applications. Such developers may have to iteratively perform fine tuning and refining of prompts to obtain accurate predictions on datasets.

Further, deploying LLMs may require significant computation resources for fine tuning the LLM model once deployed into production which may be expensive and limit accessibility due to sophisticated infrastructure. The increased complexity and efforts involved in iterations relating to training, maintaining and updating LLM's mainly require the developers to continuously explore new ways or build from scratch to optimize a model efficiency.

Therefore, there may be a need for systems and methods for predicting performance of Large Language Models (LLMs) to overcome the aforementioned limitations, in addition to providing other technical features.

### SUMMARY

This section may introduce certain objects and aspects of the present disclosure in a simplified form that are further described below in the detailed description. This summary may not intend to identify the key features or the scope of the claimed subject matter.

In one aspect, the present disclosure relates to a system for predicting performance of Large Language Models (LLMs). The system may receive a performance data associated with at least one Large Language Model (LLM) from a plurality of data sources. The system may extract a plurality of features related to a model performance from the received performance data. The system may select an appropriate Artificial Intelligence (AI)-based prediction model from among a plurality of Artificial Intelligence (AI)-based prediction models based on the extracted plurality of features. The system may apply the extracted plurality of features and the received performance data to the selected appropriate Artificial Intelligence (AI)-based prediction model. The system may predict a performance of the at least one LLM based on results of the appropriate Artificial Intelligence (AI)-based prediction model. The system may validate the predicted performance of the at least one LLM with actual performance metrics. The system may determine at least one issue in a model performance based on results of validation. The at least one issue indicates a performance gap in the at least one LLM. The system may identify a resolution for rectifying the determined at least one issue based on pre-stored rules. The system may fine tune the at least one LLM based on the predicted performance, the determined at least one issue and the identified resolution. The system may output the fine-tuned at least one LLM on a user interface of a user device.

In another aspect, the present disclosure relates to a method for predicting performance of Large Language Models (LLMs). The method includes receiving, by a processor, a performance data associated with at least one Large Language Model (LLM) from a plurality of data sources. The method includes extracting, by the processor, a plurality of features related to a model performance from the received performance data. The method includes selecting, by the processor, an appropriate Artificial Intelligence (AI)-based prediction model from among a plurality of Artificial Intelligence (AI)-based prediction models based on the extracted plurality of features. The method includes applying, by the processor, the extracted plurality of features and the received performance data to the selected appropriate Artificial Intelligence (AI)-based prediction model. The method includes predicting, by the processor, a performance of the at least one LLM based on results of the appropriate Artificial Intelligence (AI)-based prediction model. The method includes validating, by the processor, the predicted performance of the at least one LLM with actual performance metrics. The method includes determining, by the processor, at least one issue in a model performance based on results of validation. The at least one issue indicates a performance gap in the at least one LLM. The method includes identifying, by the processor, a resolution for rectifying the determined at least one issue based on pre-stored rules. The method includes fine tuning, by the processor, the at least one LLM based on the predicted performance, the determined at least one issue and the identified resolution. The method includes outputting, by the processor, the fine-tuned at least one LLM on a user interface of a user device.

In another aspect, the present disclosure relates to a non-transitory computer readable medium comprising a processor-executable instructions that cause a processor to receive a performance data associated with at least one Large Language Model (LLM) from a plurality of data sources. The processor extracts a plurality of features related to a model performance from the received performance data. The processor selects an appropriate Artificial Intelligence (AI)-based prediction model from among a plurality of Artificial Intelligence (AI)-based prediction models based on the extracted plurality of features. The processor applies the extracted plurality of features and the received performance data to the selected appropriate Artificial Intelligence (AI)-based prediction model. The processor predicts a performance of the at least one LLM based on results of the appropriate Artificial Intelligence (AI)-based prediction model. The processor validates the predicted performance of the at least one LLM with actual performance metrics. The processor determines at least one issue in a model performance based on results of validation. The at least one issue indicates a performance gap in the at least one LLM. The processor identifies a resolution for rectifying the determined at least one issue based on pre-stored rules. The processor fine tuning the at least one LLM based on the predicted performance, the determined at least one issue and the identified resolution. The processor outputs the fine-tuned at least one LLM on a user interface of a user device.

To further clarify the features of the present disclosure, a more particular description of the disclosure may follow by reference to specific embodiments thereof, which may be illustrated in the appended figures. One may appreciate that these figures depict typical embodiments of the disclosure and may therefore not to be considered limiting in scope. The disclosure may be described and explained with additional specificity and detail with the appended figures.

### BRIEF DESCRIPTION OF DRAWINGS

The accompanying drawings, which may incorporate herein, and constitute a part of this disclosure, illustrate exemplary embodiments of the disclosed methods and systems in which like reference numerals refer to the same parts throughout the different drawings. Components in the drawings may not necessarily to scale, emphasis instead being placed upon clearly illustrating the principles of the present disclosure. Some drawings may indicate the components using block diagrams and may not represent the internal circuitry of each component. The system may be appreciated by those skilled in the art that disclosure of such drawings includes the disclosure of electrical components, electronic components or circuitry commonly used to implement such components.

FIG. 1 illustrates an exemplary block diagram representation an environment 100 for predicting performance of Large Language Models (LLMs), in accordance with embodiments of the present disclosure.

FIG. 2 illustrates an exemplary block diagram representation of the system, such as those shown in FIG. 1, capable for predicting performance of Large Language Models (LLMs), in accordance with embodiments of the present disclosure.

FIG. 3 is an example block diagram representation illustrating an example method for predicting performance of Large Language Models (LLMs), in accordance with embodiments of the present disclosure.

FIG. 4 is an example tabular representation of error detection results with and without a performance prediction algorithm, in accordance with embodiments of the present disclosure.

FIG. 5 is a process flowchart illustrating an exemplary process of predicting model performance using a customized Artificial Intelligence (AI) technique, in accordance with embodiments of the present disclosure.

FIG. 6 is a block diagram representation illustrating an exemplary process of determining parameter dependency of datasets, in accordance with embodiments of the present disclosure.

FIG. 7 is a flowchart illustrating an exemplary method of dynamically selecting an appropriate Artificial Intelligence (AI)-based prediction model from among a plurality of Artificial Intelligence (AI)-based prediction models based on the extracted plurality of features, in accordance with embodiments of the present disclosure.

FIG. 8 illustrates a schematic representation of fine-tuning process along with iterations to optimize a model performance, in accordance with the embodiments of the present disclosure.

FIG. 9 illustrates an example graphical and tabular representation of a F1 score at a plurality of precision and recall values, in accordance with the embodiments of the present disclosure.

FIG. 10 is an exemplary block diagram representation of a hardware platform for implementation of the disclosed system, in accordance with embodiments of the present disclosure.

FIG. 11 is a flowchart illustrating an exemplary method for predicting performance of Large Language Models (LLMs), in accordance with embodiments of the present disclosure.

The foregoing shall be more apparent from the following more detailed description of the disclosure.

### DETAILED DESCRIPTION

In the following description, for the purposes of explanation, various specific details may set forth in order to provide a thorough understanding of embodiments of the present disclosure. The system may be apparent, however, that embodiments of the present disclosure may be practiced without these specific details. Several features described hereafter may each be used independently of one another or with any combination of other features. An individual feature may not address all of the problems discussed above or might address some of the problems discussed above. Some of the problems discussed above might not be fully addressed by any of the features described herein.

The ensuing description provides exemplary embodiments, and which may not intend to limit the scope, applicability, or configuration of the disclosure. The exemplary embodiments may provide those skilled in the art with an enabling description for implementing an exemplary embodiment. It should be understood that various changes may be made in the function and arrangement of elements without departing from the spirit and scope of the disclosure as set forth.

Specific details may be given in the following description to provide a thorough understanding of the embodiments. However, the system may be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, one may note that individual embodiments may be described as a process which may depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process may be terminated when its operations may be completed but could have additional steps not included in a figure. A process may correspond to a method, a function, a procedure, a subroutine, a subprogram, and the like. When a process corresponds to a function, its termination may correspond to a return of the function to the calling function or the main function.

The word “exemplary” and/or “demonstrative” may be used herein to mean serving as an example, instance, or illustration. For the avoidance of doubt, the subject matter disclosed herein may not limited by such examples. In addition, any aspect or design described herein as “exemplary” and/or “demonstrative” may not necessarily to be construed as preferred over other aspects or designs, nor may it meant to preclude equivalent exemplary structures and techniques known to those of ordinary skill in the art. Furthermore, to the extent that the terms “includes”, “has,” “contains,” and other similar words may be used in either the detailed description or the claims, such terms may be intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment may include in at least one embodiment of the present disclosure. Thus, the appearances of the phrases “in one embodiment” or “in an embodiment” in various places throughout this specification may not necessarily all referring to the same embodiment. Furthermore, the particular features, structures, or characteristics may be combined in any suitable manner in one or more embodiments.

The terminology used herein may for the purpose of describing particular embodiments and may not intended to be limiting of the disclosure. As used herein, the singular forms “a,” “an” and “the” may be intended to include the plural forms as well, unless the context clearly indicates otherwise. The system may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system for predicting performance of Large Language Models (LLMs). The system receives a performance data associated with at least one Large Language Model (LLM) from a plurality of data sources. The system extracts a plurality of features related to a model performance from the received performance data. The system selects an appropriate Artificial Intelligence (AI)-based prediction model from among a plurality of Artificial Intelligence (AI)-based prediction models based on the extracted plurality of features. The systems apply the extracted plurality of features and the received performance data to the selected appropriate Artificial Intelligence (AI)-based prediction model. The system predicts a performance of the at least one LLM based on results of the appropriate Artificial Intelligence (AI)-based prediction model. The system validates the predicted performance of the at least one LLM with actual performance metrics. The system determines at least one issue in a model performance based on results of validation. The at least one issue indicates a performance gap in the at least one LLM. The system identifies a resolution for rectifying the determined at least one issue based on pre-stored rules. The system fine tunes the at least one LLM based on the predicted performance, the determined at least one issue and the identified resolution. The system outputs the fine-tuned at least one LLM on a user interface of a user device.

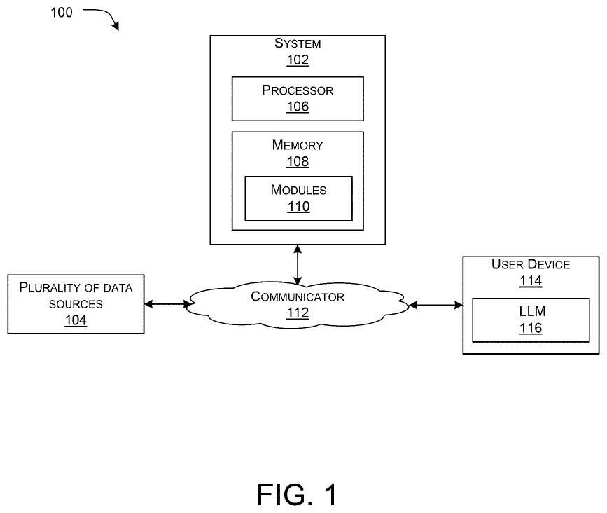

Referring now to the drawings, and more particularly to FIG. 1 through FIG. 11, where similar reference characters denote corresponding features consistently throughout the figures, there may be shown preferred embodiments, and these embodiments may be described in the context of the following exemplary system and/or method.

FIG. 1 illustrates an exemplary block diagram representation an environment 100 for predicting performance of Large Language Models (LLMs), in accordance with embodiments of the present disclosure. The environment 100 may include a system 102, a plurality of data sources 104, a user device 114, and LLM 116. In an embodiment, the system 102 may be a server system. Some examples of the server systems may be, but may not limited to, a cloud server, a centralized server, a rack server, a network server, a computer-based server, on premise server, a dedicated server, a remote server, and the like. All the system 102 of the environment 100 may be communicatively coupled to the user device 114 via a communication network 112. The communication network 112 may be a wired communication network and/or a wireless communication network.

The plurality of data sources 104 may include plurality of data sources 104 corresponding to a plurality of LLMs. The plurality of data sources 104 may be linear datasets, non-linear dataset, mid-level complex dataset, high-level complex dataset, and the like. The user device 114 may be used by at least one user. The user may be an individual, a developer, a worker, a specialist, an instructor, a supervisor, a team, an entity, an organization, a company, a facility, a bot, any other user, and combination thereof. In an embodiment, the user device 114 may be involved in developing a software and Generative Artificial Intelligence (GenAI). The entities such as the companies may include, but may not limited to, information technology (IT) organizations, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like.

Further, the user device 114 may be used to provide input and/or receive output to/from the system 102 via a user interface (not shown). The user device 114 may be one of, an electrical, an electronic, or an electromechanical, or a computing device or the like. The user device 114 may include, but may not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Furthermore, the system 102 may be implemented by way of a single device or a combination of multiple devices that may be operatively connected or networked together. The system 102 may be implemented in hardware or a suitable combination of hardware and software. Further, the system 102 may include one or more processor(s) 106, and a memory 108. The memory 108 may include a plurality of modules 110. The system 102 may be a hardware device including the processor 106 executing machine-readable program instructions for predicting performance of the LLMs. Execution of the machine-readable program instructions by the processor 106 may enable the system 102 to perform the one or more operations described herein related to predicting performance of LLMs. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors 106 may include, for example, microprocessors, microcomputers, microcontrollers, digital signal processors, central processing units, state machines, logic circuits, and/or any devices that manipulate data or signals based on operational instructions. Among other capabilities, the processor 106 may fetch and execute computer-readable instructions in the memory 108 operationally coupled with the system 102 for performing tasks such as data processing, input/output processing, and/or any other functions. Any reference to a task in the present disclosure may refer to an operation being or that may be performed on data.

Though few components and subsystems may be disclosed in FIG. 1, there may be additional components and subsystems which may not show, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art may appreciate that the hardware depicted in FIG. 1 may vary for particular implementations. For example, other peripheral devices such as an optical disk drive and the like, local area network (LAN), wide area network (WAN), wireless (for example, wireless-fidelity (Wi-Fi)) adapter, Bluetooth adapter, graphics adapter, disk controller, input/output (I/O) adapter also may be used in addition or place of the hardware depicted. The depicted example may provide explanation and is not meant to imply architectural limitations concerning the present disclosure.

Those skilled in the art may recognize that, for simplicity and clarity, the full structure and operation of all data processing systems suitable for use with the present disclosure may not being depicted or described herein. Instead, the system 102 as may be specific to the present disclosure or necessary for an understanding of the present disclosure may depicted and described. The remainder of the construction and operation of the system 102 may conform to any of the various current implementations and practices that were known in the art.

In an exemplary embodiment, the system 102 may receive the performance data associated with at least one Large Language Model (LLM) from a plurality of data sources 104. Further, the system 102 may extract a plurality of features related to a model performance from the received performance data. The plurality of features may include at least one of model architecture details, a training dataset size and diversity, a training duration and computational resources, a model complexity, a training efficiency, and hardware capabilities and hyperparameters used during training.

The system 102 may select an appropriate Artificial Intelligence (AI)-based prediction model from among a plurality of Artificial Intelligence (AI)-based prediction models based on the extracted plurality of features. The systems 102 may apply the extracted plurality of features and the received performance data to the selected appropriate Artificial Intelligence (AI)-based prediction model. The system 102 may predict a performance of the at least one LLM based on results of the appropriate Artificial Intelligence (AI)-based prediction model. The system 102 may validate the predicted performance of the at least one LLM with actual performance metrics. The actual performance metrics may include perplexity, accuracy, F1 score, BLEU score, and ROUGE score. The system 102 may determine at least one issue in a model performance based on results of validation. The at least one issue indicates a performance gap in the at least one LLM. The system 102 may identify a resolution for rectifying the determined at least one issue based on pre-stored rules. In some example embodiments, an open-source LLM model may be selected for fine-tuning with domain-specific information. In such a case, the fine-tuning process may involve training the model using large datasets. These datasets are subsequently submitted to the system 102 to forecast or predict the achievable accuracy of the target model when using these datasets. The process may be as follows. Firstly, the dataset may be sent to the prediction model, which then may forecast the performance of the LLM. The system 102 may then indicate a low performance, as measured by metrics such as F1 Score, Perplexity, Accuracy, BLEU Score, or ROUGE Score. Additionally, the system 102 may identify discrepancies between the predicted performance and the actual performance of the LLM model, using specific dataset parameters. This evaluation highlights that the dataset quality needs improvement based on the predicted parameters, as demonstrated in the example below. Consider that the prediction outcome suggests that the model's accuracy may degrade due to one of the dataset parameters. In this example, customer support dialogues may be considered. The evaluation (comparing the dataset with actual performance results) reveals that the inclusion of irrelevant or incorrectly labeled data may result in a model that produces inaccurate or inconsistent responses. The dataset in question contains customer support dialogues, primarily between customers and support agents. If, during labeling, some tweets are incorrectly categorized (for example, a complaint labeled as a query), the model may learn incorrect associations.

In some examples, a tweet expressing frustration (“I can't believe my order was delayed again!”) might be mislabeled as a “General Inquiry” instead of a “Complaint.” If the model is fine-tuned on such data, it may respond inappropriately to similar inputs. In another example, a MultiWOZ is a large-scale dataset of human-human dialogues across multiple domains (for example, booking, weather and the like). If the dataset includes dialogues with ambiguous or incomplete labeling, the model may struggle to understand the context or provide accurate responses.

In a resolution or rectification process, a pre-stored rule may suggest the following actions, perform a data cleaning or apply consistent labeling, ensuring noisy or irrelevant data is correctly labeled within the dataset, conduct another performance prediction, or observe that the predicted performance shows improvement compared to the previous prediction.

In some examples, the performance gaps may be identified as follows. Initially, the actual performance metrics of the LLM on various datasets, which have been trained using custom AI algorithm, and the Dynamic Model are collected, and submitted to the system 102. After predicting the LLM's performance on the target dataset intended for fine-tuning the actual LLM, the system 102 may evaluate the model again using the same set of metrics. Further, the system 102 may identify the performance gaps by subtracting the baseline performance metrics from the post-prediction performance metrics.

In some example embodiments, the performance metrics may include accuracy metrics. The accuracy measures the proportion of correctly predicted instances out of the total instances and is commonly used in classification tasks. The accuracy may be calculated both before and after fine-tuning to identify any performance gaps. In some example embodiments, the performance metrics may include precision, recall, and F1 score. The precision refers to the proportion of true positives among all positive predictions. The recall refers to the proportion of true positives among all actual positives. The F1 Score refers to harmonic mean of precision and recall. These metrics are particularly useful for evaluating performance on imbalanced datasets, where accuracy alone might not provide a complete picture. In some example embodiments, the performance metrics may include perplexity metrics. The perplexity measures how well a probabilistic model predicts a sample and is often used for language models. Lower perplexity indicates better performance. Performance gaps may be determined by comparing perplexity before and after fine-tuning.

In the example scenario described above, the primary performance gap identified corresponds to incorrect or irrelevant labels. In such embodiment, the model is expected to accurately classify customer queries (for example, complaints, inquiries) and provide relevant responses. If the model is fine-tuned on a dataset where complaints are mislabeled as inquiries, the system 102 may produce responses that are too neutral or irrelevant, thereby failing to adequately address the customer's frustration. This discrepancy may result in reduced accuracy, F1 scores, or customer satisfaction metrics. In such scenario, the performance gap may be measured by a significant decrease in task-specific metrics such as classification accuracy, precision, recall, and F1 score.

The system 102 may fine tune the at least one LLM based on the predicted performance, the determined at least one issue and the identified resolution. The system 102 may output the fine-tuned at least one LLM on a user interface of the user device 114.

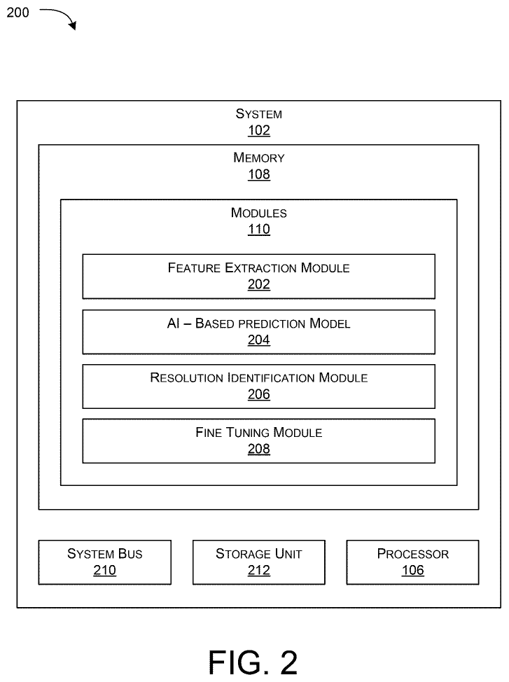

FIG. 2 illustrates an exemplary block diagram representation of the system, such as those shown in FIG. 1, capable for predicting performance of Large Language Models (LLMs), in accordance with embodiments of the present disclosure. The system 102 may also function as a computer-implemented system 102. The system 102 may include one or more processors 106, the memory 108, and a storage unit 212. The one or more processors 106, the memory 108, and the storage unit 212 may be communicatively coupled through a system bus 210 or any similar mechanism. The memory 108 includes the plurality of modules 110 in the form of programmable instructions executable by the one or more processors 106.

Further, the plurality of modules 110 includes a feature extraction module 202, an appropriate Artificial Intelligence (AI)-based prediction module 204, a resolution identification module 206, and a fine-tuning module 208.

The one or more processors 106, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more processors 106 may also include embedded controllers, such as generic or programmable logic devices or arrays, application-specific integrated circuits, single-chip computers, and the like.

The memory 108 may be a non-transitory volatile memory and a non-volatile memory. The memory 108 may be coupled to communicate with the one or more hardware processors 106, such as being a computer-readable storage medium. The one or more hardware processors 106 may execute machine-readable instructions and/or source code stored in the memory 108. A variety of machine-readable instructions may be stored in and accessed from the memory 108. The memory 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 108 may include the plurality of modules 110 stored in the form of machine-readable instructions on any of the above-mentioned storage media and may be in communication with and executed by the one or more processors 106.

The storage unit 212 may be a cloud storage or a database such as those shown in FIG. 1. The storage unit 212 may be any kind of database such as, but may not limited to, relational databases, dedicated databases, dynamic databases, monetized databases, scalable databases, cloud databases, distributed databases, any other databases, and a combination thereof.

In an exemplary embodiment, the system 102 may receive a performance data associated with at least one Large Language Model (LLM) from a plurality of data sources. The system 102 may extract a plurality of features related to a model performance from the received performance data. The system 102 may select an appropriate Artificial Intelligence (AI)-based prediction model from among a plurality of Artificial Intelligence (AI)-based prediction models based on the extracted plurality of features. In an example embodiment, the selection of appropriate Artificial Intelligence (AI)-based prediction model comprises the following process. In an example embodiment, the input dataset is first processed by the system 102, which identifies parameter dependencies and determines which variables have significant relationships with the target variables. The data then undergoes feature importance analysis to identify parameters with a high impact on outcomes. The system 102 may assess whether there is a significant correlation dependency using Correlation analysis methods, including, for example, but not limited to, Pearson, Spearman, and Kendall correlations. Further, the relationships are visualized using Partial Dependency Plots (PDPs) to illustrate the impact of each parameter on performance. The parameter dependencies are further examined using Shapley Values and SHAP (Shapley Additive Explanations) to understand the contribution of each feature to specific predictions. A permutation importance is employed by shuffling a feature's values to evaluate the importance of each feature, which may indicate parameter dependency. Further, feature selection techniques such as recursive feature elimination and L1 regularization are applied to identify key features that influence the target variable. After completing these steps, the system 102 then learns the parameters and their relationships within the dataset. The system 102 then constructs a relational graph and prepares to design the custom algorithm-based dynamic model (also referred herein as appropriate Artificial Intelligence (AI)-based prediction model) for prediction.

The relational graph is analyzed to detect whether the dataset exhibits linear, multilinear, or non-linear characteristics. If the dataset is detected as Non-Linear, then a curve in the residuals suggests the need for a high-degree polynomial to achieve the appropriate fit. If the dataset size is large, the system 102 adapts to the polynomial. A domain knowledge assists in deciding whether to use a polynomial fit. Greater complexity in non-linearity necessitates a polynomial approach. Alternatively, for linear or multi-linear data, domain hypotheses or subject matter expertise may suggest that two variables might interact in a specific way to influence the outcome, leading to the application of Interaction Fit. This approach is applied when complex relationships exist, there is a lack of fit, or when unusual residual patterns are detected, and when predictions fail to capture the complexity of the relationships. Based on the parameter analysis and relational graph, if a need for Interaction Fit is detected in a linear or multilinear scenario, it is applied to the Dynamic Model using the Custom Algorithm. In the case of Non-Linear data, a polynomial fit is applied to the Dynamic Model using the Custom Algorithm.

In some examples, a synthetic Dataset is created using the process below. A dataset with two features (X1 and X2) is created that interact to influence the target y. For example, X1: Feature 1, X2: Feature 2 and y: Target, defined as equation (1):

$$y = 3 X 1 + 2 X 2 + 4 X 1 \times X 2 y = 3 X 1 + 2 X 2 + 4 X 1 \backslash times X 2 y = 3 X 1 + 2 X 2 + 4 X 1 \times X 2 \qquad equation ( 1 )$$

In this case, the interaction term 4X1×X24X1\times X24X1×X2 implies that the effect of X1 on y depends on the value of X2 and vice versa. This will give us a dataset as shown in Table. 1 below:

TABLE 1

| X1 | X2 | y |
|---|---|---|
| 0 | 0 | 0 |
| 0 | 1 | 2 |
| 1 | 0 | 3 |
| 1 | 1 | 9 |

Further, as a next step, SHAP Values on sample datasets are calculated. SHAP values are based on Shapley values from cooperative game theory. For a simple two-feature model, the SHAP value for a feature XiX_iXi may be computed as:

$$SHAP ( Xi ) = Σ S ⊆ \{ X 1 , X 2 \} \backslash \{ Xi \} \vert S \vert ! ( M - \vert S \vert - 1 ) ! M ! [ f ( S ⋃ \{ Xi \} ) - f ( S ) ] \backslash text \{ SHAP \} ( X\_i ) = \backslash sum\_ \{ S \backslash subseteq \backslash \{ X\_ 1 , X\_ 2 \backslash \} \backslash setminus \backslash \{ X\_i \backslash \} \} \backslash frac \{ \vert S \vert ! ( M - \vert S \vert - 1 ) ! \} \{ M ! \} \backslash left [ f ( S \backslash cup \backslash \{ X\_i \backslash \} ) - f ( S ) \backslash right ] SHAP ( Xi . = Σ S ⊆ \{ X 1. X 2 \} \backslash \{ Xi . \} M ! \vert S \vert ! ( M - \vert S \vert - 1 ) ! [ f ( S ⋃ \{ Xi \} ) - f ( S ) ] \qquad equation ( 2 )$$

Where: SSS is a subset of the features, MMM is the total number of features (2 in this case), f(S)f(S)f(S) is the model's prediction when the features in subset SSS are included.

In this scenario, the SHAP values for X1 and X2 are calculated as below:

For X1:

$$\begin{matrix}S = \{ \} S = \backslash \{ \backslash \} S = \{ \} ( Empty set ) & equation ( 3 ) \\ f ( \{ \} ) = 0 f ( \backslash \{ \backslash \} ) = 0 f ( \{ \} ) = 0 \\ ( no features , hence , the base value is 0 ) & equation ( 4 ) \\ f ( \{ X 1 \} ) = 3 \times X 1 = 3 \times 1 = 3 f ( \backslash \{ X 1 \backslash \} ) = 3 \backslash times X 1 = 3 \backslash times 1 = 3 f ( \{ X 1 \} ) = 3 \times X 1 = 3 \times 1 = 3 \\ Contribution : 3 - 0 = 33 - 0 = 33 - 0 = 3 & equation ( 5 ) \\ S = \{ X 2 \} S = \backslash \{ X 2 \backslash \} S = \{ X 2 \} : & equation ( 6 ) \\ F \{ X 2 \} ) = 2 \times X 2 = 2 \times 1 = 2 f ( \backslash \{ X 2 \backslash \} ) = 2 \backslash times X 2 = 2 \backslash times 1 = 2 f ( \{ X 2 \} ) = 2 \times X 2 = 2 \times 1 = 2 & equation ( 7 ) \\ f ( X \{ 1 , X 2 \} ) = 3 \times X 1 + 2 \times X 2 + 4 \times X 1 \times X 2 = 3 \times 1 + 2 \times 1 + 4 \times 1 \times 1 = 9 f \{ \backslash X 1 , X 2 \backslash \} ) = 3 \backslash times X 1 + 2 \backslash times X 2 + 4 \backslash times X 1 \backslash times X 2 = 3 \backslash times 1 + 2 \backslash times 1 + 4 \backslash times 1 \backslash times 1 = 9 f ( \{ X 1 , X 2 \} ) = 3 \times X 1 + 2 \times X 2 + 4 \times X 1 ∴ X 2 = 3 \times 1 + 2 \times 1 + 4 \times 1 \times 1 = 9 & equation ( 8 )\end{matrix}$$

Contribution: 9−2=79−2=79−2=7 The average SHAP value for X1:

$$SHAP ( X 1 ) = 12 \times ( 3 + 7 ) = 5 \backslash text \{ SHAP \} ( X 1 ) = \backslash frac \{ 1 \} \{ 2 \} \backslash times ( 3 + 7 ) = 5 SHAP ( X 1 ) = 21 X ( 3 + 7 ) = 5 \qquad equation ( 9 )$$

For X2:

$$\begin{matrix}S = \{ \} S = \backslash \{ \backslash \} S = \{ \} ( Empty set ) : & equation ( 10 ) \\ f ( \{ \} ) = 0 f ( \backslash \{ \backslash \} ) = 0 f ( \{ \} ) = 0 & equation ( 11 ) \\ f ( \{ X 2 \} ) = 2 \times X 2 = 3 \times 1 = 2 f ( \backslash \{ X 2 \backslash \} ) = 2 \backslash times X 2 = 2 \backslash times 1 = 2 f ( \{ X 2 \} ) = 2 \times X 2 = 2 \times 1 = 2 & equation ( 12 )\end{matrix}$$

Contribution: 2−0=22−0=22−0=2

$$\begin{matrix}S = \{ X 1 \} S = \backslash \{ X 1 \backslash \} S = \{ X 1 \} : & equation ( 13 ) \\ f ( \{ X 1 \} ) = 3 \times X 1 = 3 \times 1 = 3 f ( \backslash \{ X 1 \backslash \} ) = 3 \backslash times X 1 = 3 \backslash times 1 = 3 f ( \{ X 1 \} ) = 3 \times X 1 = 3 \times 1 = 3 & equation ( 14 ) \\ f ( \{ X 1 , X 2 \} ) = 3 \times X 1 + 2 \times X 2 + 4 \times X 1 \times X 2 = 9 f ( \backslash \{ X 1 , X 2 \backslash \} ) = 3 \backslash times X 1 + 2 \backslash times X 2 + 4 \backslash times X 1 \backslash times X 2 = 9 f ( \{ X 1 , X 2 \} ) = 3 \times X 1 + 2 \times X 2 + 4 \times X 1 \times X 2 = 9 & equation ( 15 )\end{matrix}$$

Contribution: 9−3=69−3=69−3=6

The average SHAP value for X2:

$$SHAP ( X 2 ) = 12 \times ( 2 + 6 ) = 4 \backslash text \{ SHAP \} ( X 2 ) = \backslash frac \{ 1 \} \{ 2 \} \backslash times ( 2 + 6 ) = 4 SHAP ( X 2 ) = 21 \times ( 2 + 6 ) = 4 \qquad equation ( 16 )$$

As a next step, interaction effects are calculated. To determine the interaction effect between X1 and X2, how the combined contribution of X1 and X2 differs from the sum of their individual contributions is determined.

The interaction term X1×X2X1 \times X2X1×X2 . . . equation (17) directly contributes 4×X1×X24 \times X1 \times X24×X1×X2 . . . equation (18) to y.

For example, when both X1 and X2 are 1, the interaction effect is:

$$\begin{matrix}Interaction effect = f ( \{ X 1 , X 2 \} ) - f ( \{ X 1 \} ) - f ( \{ \} ) = 9 - 3 - 2 + 0 \\ = 4 \backslash text \{ Interaction effect \} \\ = f ( \backslash \{ X 1 , X 2 \backslash \} ) - f ( \backslash \{ X 1 \backslash \} ) - f ( \backslash \{ X 2 \backslash \} ) + f ( \backslash \{ \backslash \} ) \\ = 9 - 3 - 20 = 4 Interaction effect \\ = f ( \{ X 1 , X 2 \} ) - f ( \{ X 1 \} ) - f ( \{ X 2 \} ) + f ( \{ \} ) = 9 - 3 - 2 + 0 \\ = 4\end{matrix} \qquad equation ( 19 )$$

This shows that the interaction between X1 and X2 adds an additional 4 units to the prediction when both features are present.

In summary, the SHAP Value for X1: 5, SHAP Value for X2: 4 and Interaction Effect (X1, X2): 4.

This example demonstrates the basic concept of SHAP values and how interactions between features may be computed. In real-world scenarios, SHAP values are typically computed using libraries such as, SHAP.

In some example embodiments, SHAPLEY calculation and Interaction Effects for interaction fit appropriate model are dynamically generated for set of parameters in the dataset using the following process. The system 102 creates a dataset for a regression task. The system 102 further trains a model to predict the target. The system 102 then calculates SHAP values to determine the importance of features. The system 102 then analyses interactions between features using SHAP interaction values. Further, the system 102 finds and interprets multicollinear relationships. Given that X1 and X2 are highly correlated, a significant interaction between them is expected. The multicollinearity is further analyzed by checking a Variance Inflation Factor (VIF) from statistical models, statistical outliers, influence import variance, and inflation factor.

The system 102 may apply the extracted plurality of features and the received performance data to the selected appropriate Artificial Intelligence (AI)-based prediction model. The system 102 may predict a performance of the at least one LLM based on results of the appropriate Artificial Intelligence (AI)-based prediction model. The system 102 may validate the predicted performance of the at least one LLM with actual performance metrics. The system 102 may determine at least one issue in a model performance based on results of validation. The at least one issue indicates a performance gap in the at least one LLM. The system 102 may identify a resolution for rectifying the determined at least one issue based on pre-stored rules. The system 102 may fine tune the at least one LLM based on the predicted performance, the determined at least one issue and the identified resolution. The system 102 may output the fine-tuned at least one LLM on a user interface of the user device 114.

In an exemplary embodiment, the feature extraction module 202 may cause the processor 106 to receive a performance data associated with at least one Large Language Model (LLM) from a plurality of data sources. The performance data associated with the at least one LLM includes at least one of benchmark results from standardized Natural Language Processing (NLP) tasks, the performance metrics, a data on model size, training hyperparameters, and computational resources used.

Further, the feature extraction module 202 may cause the processor 106 to extract the plurality of features related to the model performance from the received performance data. In extracting the plurality of features related to the model performance from the received performance data, the feature extraction module 202 may cause the processor 106 to preprocess the received performance data by performing at least one of a data normalization and a missing value detection. The data normalization and missing value detection are crucial when preparing performance data for prediction modelling datasets, ensuring that the data is both consistent and complete. When working with LLM performance data, normalization and missing value detection are crucial steps to ensure the data is consistent, reliable, and ready for analysis or model fine-tuning. Normalization may be a process of adjusting values measured on different scales to a common scale, often between 0 and 1. This is especially important when comparing performance metrics (like F1 scores) across different datasets, as the range of these scores may vary. In one example, consider historical F1 scores performance metrics for an LLM on three different datasets as shown in Table. 2:

TABLE 2

| Dataset | F1 Score |
|---|---|
| Dataset A | 0.75 |
| Dataset B | 0.60 |
| Dataset C | 0.85 |

To normalize these F1 scores, a min-max normalization method may be used, which is calculated as:

$$\begin{matrix}Normalized F 1 = F 1 - F 1 min F 1 max - F 1 min \backslash text \{ Normalized F 1 \} \\ = \backslash frac \{ \backslash text \{ F 1 \} - \backslash text {\{ F 1 \}}_{\{ \backslash min \}} \} \{ \backslash text {\{ F 1 \}}_{\{ \backslash max \}} - \\ \backslash text {\{ F 1 \}}_{\{ \backslash min \}} \} Normalized F 1 \\ = F 1 max - F 1 min F 1 - F 1 min\end{matrix} \qquad equation ( 20 )$$

Where: F1 min\text{F1}_{{\min}F1min} is the minimum F1 score in the data (0.60 in this case).

F1 max\text{F1}_{\max}F1 max is the maximum F1 score in the data (0.85 in this case).

Applying this to the data as shown below in Table 3:

TABLE 3

| | F1 | |
|---|---|---|
| Dataset | Score | Normalized F1 Score |
| Dataset | 0.75 | 0.75 − 0.600.85 − 0.60 = 0.60\frac {0.75 − 0.60} {0.85 − 0.60} = |
| A | | 0.600.85 − 0.600.75 − 0.60 = 0.60 |
| Dataset | 0.60 | 0.60 − 0.600.85 − 0.60 = 0.00\frac {0.60 − 0.60} {0.85 − 0.60} = |
| B | | 0.000.85 − 0.600.60 − 0.60 = 0.00 |
| Dataset | 0.85 | 0.85 − 0.600.85 − 0.60 = 1.00\frac {0.85 − 0.60} {0.85 − 0.60} = |
| C | | 1.000.85 − 0.600.85 − 0.60 = 1.00 |

In this case, all F1 scores are on a scale from 0 to 1, making them comparable across datasets.

In an embodiment, missing value detection may refer to a process of identifying gaps or missing entries in the dataset. This is critical for maintaining data integrity before performing any analysis or fine-tuning.

For example, consider the following performance data where some values are missing Table 4:

TABLE 4

| Dataset | F1 Score | Precision | Recall |
|---|---|---|---|
| Dataset A | 0.75 | 0.78 | 0.72 |
| Dataset B | 0.60 | 0.65 | NaN |
| Dataset C | NaN | 0.88 | 0.80 |

Below are the steps for handling missing values: Initially, locations of the missing values (NaN) are identified. In this case, Dataset B is missing the Recall value, and Dataset C is missing the F1 Score. Depending on the situation, these missing values are imputed (fill in). Common methods may include, for example mean/median imputation, where missing values are replaced with the mean or median of the available data. Another approach may be to use forward/backward fill, where the previous or next available value are used to fill in the gap. In another approach, a model-based imputation method, a predictive model may be used to estimate the missing values. Assuming the missing F1 score is imputed for Dataset C with the mean of the available F1 scores:

$$Mean F 1 Score = 0.75 + 0.602 = 0.675 \backslash frac \{ 0.75 + 0.6 \} \{ 2 \} = 0.6752 \text{.75} + 0.6 = 0.675 \qquad equation ( 21 )$$

TABLE 5

| Dataset | F1 Score | Precision | Recall |
|---|---|---|---|
| Dataset A | 0.75 | 0.78 | 0.72 |
| Dataset B | 0.60 | 0.65 | Impute: 0.71 (mean Recall) |
| Dataset C | Impute: 0.675 | 0.88 | 0.80 |

Hence, normalization helps compare metrics across different scales and missing value detection ensures that gaps in data do not lead to biased or incomplete analysis.

The feature extraction module 202 may cause the processor 106 to extract the plurality of features related to the model performance from the preprocessed performance data. The plurality of features includes at least one of model architecture details, a training dataset size and diversity, a training duration and computational resources, a model complexity, a training efficiency, and hardware capabilities and hyperparameters used during training.

In an exemplary embodiment, the appropriate Artificial Intelligence (AI)-based prediction module 204 may cause the processor 106 to select an appropriate Artificial Intelligence (AI)-based prediction model from among a plurality of Artificial Intelligence (AI)-based prediction models based on the extracted plurality of features. Further, the appropriate Artificial Intelligence (AI)-based prediction module 204 may cause the processor 106 to apply the extracted plurality of features and the received performance data to the selected appropriate Artificial Intelligence (AI)-based prediction model. Furthermore, the appropriate Artificial Intelligence (AI)-based prediction module 204 may cause the processor 106 to predict a performance of the at least one LLM based on results of the appropriate Artificial Intelligence (AI)-based prediction model. Furthermore, the appropriate Artificial Intelligence (AI)-based prediction module 204 may cause the processor 106 to validate the predicted performance of the at least one LLM with actual performance metrics.

In an exemplary embodiment, to predict the performance of the at least one LLM based on the results of the appropriate Artificial Intelligence (AI)-based prediction model 204, the appropriate Artificial Intelligence (AI)-based prediction module 204 may cause the processor 106 to analyze a plurality of parameters comprised in the performance data to identify at least one of dependent variables and independent variables. The plurality of parameters corresponds to input design parameters. The appropriate Artificial Intelligence (AI)-based prediction module 204 may cause the processor 106 to determine a parameter dependency for each of the plurality of parameters by determining relationship between each of the plurality of parameters using a dependency Artificial Intelligence (AI)-based graph. The appropriate Artificial Intelligence (AI)-based prediction module 204 may cause the processor 106 to determine an eligibility of the analyzed plurality of parameters for prediction using at least one of a linear function and a multiple regression function based on the determined parameter dependency. The appropriate Artificial Intelligence (AI)-based prediction module 204 may cause the processor 106 to perform a plurality of parameter analysis on the plurality of parameters based on the determined eligibility and the determined parameter dependency. The plurality of parameter analysis includes, such as for example, but not limited to, a feature importance analysis, a correlation analysis, partial dependency plots, a permutation importance analysis, and a feature selection analysis and the like.

In an exemplary embodiment, the appropriate Artificial Intelligence (AI)-based prediction module 204 may cause the processor 106 to generate the appropriate Artificial Intelligence (AI)-based prediction model for prediction based on the performed plurality of parameter analysis. The appropriate Artificial Intelligence (AI)-based prediction module 204 may cause the processor 106 to predict the performance of the at least one LLM based on the results of the generated appropriate Artificial Intelligence (AI)-based prediction model.

In an exemplary embodiment, to generate the appropriate Artificial Intelligence (AI)-based prediction model for prediction based on the performed plurality of parameter analysis, the appropriate Artificial Intelligence (AI)-based prediction module 204 may cause the processor 106 to compute the input design parameters comprised in the performance data. The appropriate Artificial Intelligence (AI)-based prediction module 204 may cause the processor 106 to determine an applicability of the linear function and the multiple regression function by analyzing the computed input design parameters. The appropriate Artificial Intelligence (AI)-based prediction module 204 may cause the processor 106 to perform one of a linear analysis and a multiple regression analysis on the computed input design parameters to generate prediction parameters based on the determination. The appropriate Artificial Intelligence (AI)-based prediction module 204 may cause the processor 106 to compute interaction terms between the input design parameters based on the performed one of the linear analysis and the multiple regression analysis. The interaction terms correspond to a statistical model representing a combined result of a two or more independent variables on a dependent variable. The appropriate Artificial Intelligence (AI)-based prediction module 204 may cause the processor 106 to perform interaction computations on the input design parameters based on the computed interaction terms. The interaction computations include at least one of, for example, but not limited to a logistic regression, an isotonic regression, and a Multivariate Adaptive Regression Splines (MARS) and the like. The appropriate Artificial Intelligence (AI)-based prediction module 204 may cause the processor 106 to generate the appropriate Artificial Intelligence (AI)-based prediction model based on the prediction parameters and interaction computation results.

In an exemplary embodiment, to select the appropriate Artificial Intelligence (AI)-based prediction model from among the plurality of Artificial Intelligence (AI)-based prediction module based on the extracted plurality of features, the appropriate Artificial Intelligence (AI)-based prediction module 204 may cause the processor 106 to perform a feature importance analysis on the performance data to identify the plurality of features. The feature importance analysis includes at least one of, for example, but not limited to, decision trees technique, random forests technique, and a gradient boosting technique and the like. The feature importance analysis may be performed by using a permutation importance by shuffling values of the plurality of features to assess respective importance and indicating a parameter dependency. The appropriate Artificial Intelligence (AI)-based prediction module 204 may cause the processor 106 to perform a correlation analysis on the performance data to identify relationships between the plurality of features. The correlation analysis computes correlation coefficients, selected from one of, such as for example, but not limited to, a Pearson, Spearman, or Kendall technique to quantify a strength of the relationships and the correlation analysis identifies parameter dependencies as one of a positive, a negative, and a no relationship value based on the correlation coefficients.

The appropriate Artificial Intelligence (AI)-based prediction module 204 may cause the processor 106 to detect parameter dependencies between the plurality of features based on results of the correlation analysis. The parameter dependencies may be visualized using one of, for example, but not limited to, partial dependency plots (PDP), an interpreted using Shapley values and Shapley Additive exPlanations (SHAP) for assessing a contribution of each feature to the prediction. The appropriate Artificial Intelligence (AI)-based prediction module 204 may cause the processor 106 to select the appropriate Artificial Intelligence (AI)-based prediction model from among the plurality of Artificial Intelligence (AI)-based prediction models based on the detected parameter dependencies and a nature of the performance data. The appropriate Artificial Intelligence (AI)-based prediction model may be selected from the plurality of Artificial Intelligence (AI)-based prediction models optimized for a plurality of types of data, comprising at least one of, for example, but not limited to, interaction-based fits, non-linear data fits, and monotonic relations.

In an exemplary embodiment, to select the appropriate Artificial Intelligence (AI)-based prediction model from among the plurality of Artificial Intelligence (AI)-based prediction models based on the detected parameter dependencies and the nature of the performance data, the appropriate Artificial Intelligence (AI)-based prediction module 204 may cause the processor 106 to configure to select an interaction appropriate-fit model as the appropriate Artificial Intelligence (AI)-based prediction model in response to determining that the performance data indicates exceed an interaction level between the plurality of features. The appropriate Artificial Intelligence (AI)-based prediction module 204 may cause the processor 106 to select a Multivariate Adaptive Regression Splines (MARS) appropriate-fit model as the appropriate Artificial Intelligence (AI)-based prediction model in response to detecting non-linear data fits in the performance data. The appropriate Artificial Intelligence (AI)-based prediction module 204 may cause the processor 106 to select a polynomial appropriate-fit model as the appropriate Artificial Intelligence (AI)-based prediction model in response to detecting a presence of a non-linear relationship between the plurality of features. The appropriate Artificial Intelligence (AI)-based prediction module 204 may cause the processor 106 to select an isotonic appropriate-fit model as the appropriate Artificial Intelligence (AI)-based prediction model in response to detecting a monotonic relationship between the plurality of features.

In an exemplary embodiment, the appropriate Artificial Intelligence (AI)-based prediction module 204 may cause the processor 106 to apply the feature selection techniques, including, for example, but not limited to, recursive feature elimination and L1 regularization, to refine the list of key features influencing the target variable. The appropriate Artificial Intelligence (AI)-based prediction module 204 includes a dependency detection module (not shown) that extracts parameters to detect dependencies in datasets where variable relationships have significant impact on the target variable. The nature of the data includes, such as for example, considerations of dimensionality, feature interaction, and the presence of non-linear or monotonic relationships, which influence the selection of the appropriate prediction model. In one example, Shapley values and SHAP may be employed to quantify the importance of each feature, with larger absolute Shapley values indicating greater importance for prediction. However, any other method for quantifying the parameter importance may also be used. The dependency detection process involves generating relation graphs and dynamic modeling of computed parameters to better understand complex feature interactions.

In an exemplary embodiment, the appropriate Artificial Intelligence (AI)-based prediction module 204 may cause the processor 106 to validate the predicted performance of the at least one LLM with actual performance metrics. The appropriate Artificial Intelligence (AI)-based prediction module 204 may cause the processor 106 to compare the predicted performance of the at least one LLM with a ground truth data. In an example embodiment, ground truth data refers to the actual, real-world information or results that serve as a baseline or reference to evaluate the accuracy of the prediction model which generate predicted performance on the datasets which are given as input to this custom AI algorithm based prediction model developed a dynamic model based on the type of datasets are used. For this prediction custom dynamic model, ground truth data is crucial for assessing how accurately the model's outputs align with the correct or expected responses. Some examples of ground truth data are as follows. Consider an LLM designed to classify news articles into categories such as, for example, “Politics,” “Sports,” “Technology,” and “Health.” To evaluate the model, a dataset of news articles is required where each article has already been correctly labeled with one of these categories. This labeled dataset represents the ground truth. Ground Truth Data Example may include Article 1: “The government has passed a new bill on healthcare reform.”, Ground Truth Label: Politics, Article 2: “The local team won the championship after a thrilling match.”, Ground Truth Label: Sports, Article 3: “New AI advancements are transforming the technology landscape.”, Ground Truth Label: Technology, Article 4: “Regular exercise has been proven to improve mental health.”, Ground Truth Label: Health and the like.

In such a case, model predicts on each article and assigns a category label. For example, prediction for Article 1: Politics, prediction for Article 2: Sports, prediction for Article 3: Technology, prediction for Article 4: Health, comparison with Ground Truth: The predicted labels are compared against the ground truth labels. If the predicted label matches the ground truth label, it is considered correct.

The appropriate Artificial Intelligence (AI)-based prediction module 204 may cause the processor 106 to compute at least one actual performance metric based on the comparison. The actual performance metric includes at least one of, such as for example, but not limited to, an accuracy score, a precision value, a recall value, a perplexity score, a BiLingual Evaluation Understudy (BLEU) Score, and a Recall-Oriented Understudy for Gisting Evaluation (ROUGE) Score. The appropriate Artificial Intelligence (AI)-based prediction module 204 may cause the processor 106 to determine a performance level of the at least one LLM based on the computed at least one actual performance metric. The appropriate Artificial Intelligence (AI)-based prediction module 204 may cause the processor 106 to validate the predicted performance of the at least one LLM based on the determined performance level.

In an example embodiment, the BLEU score (Bilingual Evaluation Understudy) and the ROUGE score (Recall-Oriented Understudy for Gisting Evaluation) are two metrics used for evaluating the quality of prediction model in this case. Both metrics compare the generated text (hypothesis) to a reference text (usually human-generated) to assess its quality, however, are performed in different ways.

In an example embodiment, the BLEU score may be used for evaluating machine translation however may also be applied to other tasks such as, for example, text generation. The BLEU score measures how closely the generated text matches one or more reference texts. The BLEU calculates the precision of n-grams (continuous sequences of words) in the generated text. Typically, BLEU uses n-grams of different lengths (unigrams, bigrams, trigrams, and the like.). In another example, the BLEU uses “modified precision” to ensure that n-grams are not over-counted if they appear multiple times in the generated text however fewer times in the reference text. To prevent overly short hypotheses from receiving high scores, the BLEU includes a brevity penalty that penalizes generated texts that are shorter than the reference. Further, the BLEU score is calculated as the geometric mean of the n-gram precisions, multiplied by the brevity penalty. This score is a number between 0 and 1, with 1 being a perfect match to the reference text. The BLEU score formula may be summarized as:

$$BLEU = BP \times exp ( Σ n = 1 Nwnlo gpn ) \backslash text \{ BLEU \} = BP \backslash times \backslash exp \backslash left ( \backslash {sum}_{{\{ n = 1 \}}_{n}^{\{ N \} w} \backslash log} {p}_{n \backslash r ight} ) BLEU = BP \times exp ( n = 1 Σ Nwnlogpn ) \qquad equation ( 31 )$$

Where: BPBPBP is the brevity penalty, pnp_npn is the modified precision for n-grams, wnw_nwn is the weight given to each n-gram precision (usually equal).

In an example embodiment, the ROUGE score (Recall-Oriented Understudy for Gisting Evaluation) is used for evaluating text summarization however may also be applied to other tasks such as, for example, machine translation. Unlike BLEU, which focuses on precision, ROUGE focuses on recall. A ROUGE-N variant score measures the overlap of n-grams between the generated text and the reference text. The ROUGE-N may be computed for different values of n (example, ROUGE-1 for unigrams, ROUGE-2 for bigrams). A ROUGE-L variant score measures the longest common subsequence (LCS) between the generated text and the reference text. This score captures the sentence-level structure similarity. A ROUGE-S(ROUGE-Skip) variant score measures the overlap of skip-bigrams (pairs of words in their sentence order, allowing gaps between them) between the generated and reference texts.

For ROUGE-N, the recall is the ratio of the number of overlapping n-grams to the total number of n-grams in the reference text. Higher recall indicates that more of the reference's content is captured in the generated text. The ROUGE may also be used to compute precision and F-score; however, it is most commonly associated with recall. The ROUGE-N score is typically calculated as:

$$ROUGE - N = Number of overlapping n - gramsTotal n - grams in the reference text \backslash text \{ ROUGE - N \} = \backslash frac \{ \backslash text \{ Number of overlapping n - grams \} \} \{ \backslash text \{ Total n - grams in the reference text \} \} ROUGE - N = Total n - grams in the reference textNumber of overlapping n - grams \qquad equation ( 32 )$$

The BLEU score focuses on precision, measures how much of the generated text matches the reference. The BLEU score penalizes shorter translations and rewards closer matches to the reference text. The ROUGE score focuses on recall, measures how much of the reference text is captured in the generated text. This score is more lenient with variations in word order and is particularly useful for summarization tasks.

In one example embodiment, a reference sentence may be “The quick brown fox jumps over the lazy dog” and a generated Sentence (Hypothesis) may be “The fast brown fox jumped over a lazy dog.” For calculating the BLEU Score, the sentences are first tokenized. Reference: [“The”, “quick”, “brown”, “fox”, “jumps”, “over”, “the”, “lazy”, “dog”] and Hypothesis: [“The”, “fast”, “brown”, “fox”, “jumped”, “over”, “a”, “lazy”, “dog” ]. Further, a Modified Precision for n-grams is calculated. For Unigrams (1-gram), the overlap: [“The”, “brown”, “fox”, “over”, “lazy”, “dog” ], precision=6/9 (6 matched unigrams out of 9 in the hypothesis). For Bigrams (2-gram), the Overlap: [“brown fox”, “over lazy”, “lazy dog”] and precision=3/8 (3 matched bigrams out of 8 in the hypothesis). For Trigrams (3-gram), the Overlap: [“over lazy dog”] and Precision=1/7 (1 matched trigram out of 7 in the hypothesis). As a next step, a Brevity Penalty (BP) is calculated. Reference length=9 tokens, Hypothesis length=9 tokens. Since the lengths are equal, BP=1 (no penalty).

Further, the BLEU Score is calculated as below:

$$BLEU score = BP \times exp ( 13 Σ n = 13 log pn ) BP \backslash times \backslash exp \backslash left ( \backslash frac \{ 1 \} \{ 3 \} \backslash sum\_ \{ n = 1 \} \hat{} \{ 3 \} \backslash log p\_n \backslash right ) BP \times exp ( 31 Σ n = 13 log pn ) \qquad equation ( 33 )$$

In this case, p1=69p_1=\frac {6}{9}p1=96, p2=38p_2=\frac {3}{8}p2=83, p3=17p_3=\frac {1}{7}p3=71

$$BLEU score \approx exp f 0 ( 13 ( log f 0 \; 69 + log f 0 \; 38 + log f 0 \; 17 ) ) \backslash exp \backslash left ( \backslash frac \{ 1 \} \{ 3 \} ( \backslash log \backslash frac \{ 6 \} \{ 9 \} + \backslash log \backslash frac \{ 3 \} \{ 8 \} + \backslash log \backslash frac \{ 1 \} \{ 7 \} ) \backslash right ) exp ( 31 ( log 96 + log 83 + log 71 ) )$$

BLEU score≈0.34 (depending on how many n-grams include and weights. Hence, BLEU≈0.34.

In some embodiments, ROUGE-1 (Unigram) and ROUGE-L (Longest Common Subsequence) are further calculated. For ROUGE-1, reference Unigrams: [“The”, “quick”, “brown”, “fox”, “jumps”, “over”, “the”, “lazy”, “dog” ], Hypothesis Unigrams: [“The”, “fast”, “brown”, “fox”, “jumped”, “over”, “a”, “lazy”, “dog” ], Overlap Unigrams: [“The”, “brown”, “fox”, “over”, “lazy”, “dog” ], Recall=Overlap/Reference≈6/9=0.67, Precision=Overlap/Hypothesis=6/9≈0.67.

$$Further , the F 1 - Score = 2 \times ( Precision \times Recall ) / ( Precision + Recall ) \approx 0.67 \qquad equation ( 34 )$$

The LCS of Reference and Hypothesis=[“The”, “brown”, “fox”, “over”, “lazy”, “dog” ](length=6), ROUGE-L Recall=LCS length/Reference length=6/9≈0.67, ROUGE-L Precision=LCS length/Hypothesis length=6/9≈0.67, ROUGE-L F1-Score≈0.6, hence for this example: ROUGE-1 Recall≈0.67, ROUGE-L Recall≈0.67

Summary of the Example Scores include BLEU Score: =0.34, ROUGE-1 Recall: ≈0.67, ROUGE-L Recall: ≈0.67. These scores reflect different aspects of the generated text. The BLEU Score is relatively low because it penalizes mismatched n-grams and considers brevity. The ROUGE Scores are higher because they focus more on the recall of matching n-grams or sequences. These results indicate that while the generated text captures some of the content, it deviates in ways that affect its overall fluency and accuracy.

In an exemplary embodiment, to fine tune the at least one LLM based on the predicted performance, the determined at least one issue and the identified resolution, the fine-tuning module 208 may cause the processor 106 to evaluate a plurality of relationships between the extracted plurality of features using a relation graph-based dynamic modeling technique. The fine-tuning module 208 may cause the processor 106 to determine a model complexity, a data size, a domain knowledge, and residual graph characteristics associated with the extracted plurality of features based on the evaluated plurality of relationships. The fine-tuning module 208 may cause the processor 106 to determine an appropriate modeling approach for predicting the performance of the at least one LLM based on the determined model complexity, the data size, the domain knowledge, and the residual graph characteristics using a decision graph. The decision graph may determine the appropriate modeling approach to be one of a polynomial model and an interaction-based model and the polynomial model may be selected in response to determining that residuals display a curve indicating a non-linearity, the dataset size may be large, and a domain knowledge indicates a polynomial fit and the interaction-based model may be selected in response to determining complex relationship levels between the plurality of features, and unusual residual patterns. The fine-tuning module 208 may cause the processor 106 to compute a model fit score for the selected model by assessing the performance of the at least one LLM. The fine-tuning module 208 may cause the processor 106 to fine-tune the at least one LLM based on the computed model fit score.

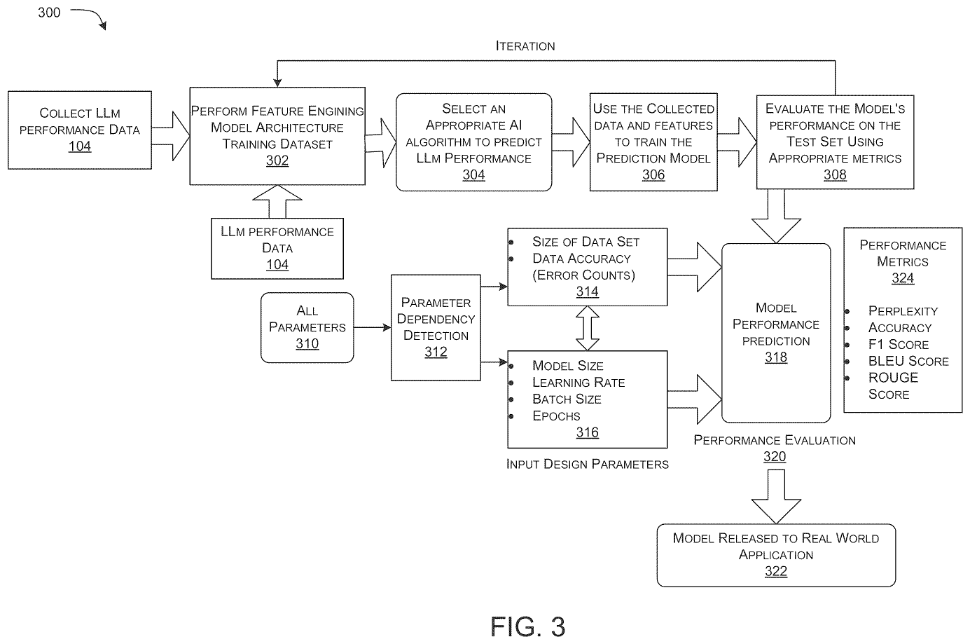

FIG. 3 is an example block diagram representation illustrating an example method 300 for predicting performance of Large Language Models (LLMs), in accordance with embodiments of the present disclosure.

The method 300 includes collecting, by the processor 106, a plurality of data sources 104. This involves collecting performance data on the LLM performance across a range of tasks and configurations. This may involve benchmark results from standardized NLP tasks, performance metrics from deploying models in real-world scenarios, data on model size, training hyperparameters, and computational resources used.

At step 302, the method 300 includes performing, by the processor 106, a plurality of feature extracting. This involves extracting using a model architecture training dataset. The extracted features may influence model performance. This may involve potential features. The potential features may be model architecture details such as number of layers, attention mechanism, and the like. The potential features further include training dataset size, and diversity. The potential features include training duration and computational resources. The potential features further include hyperparameters used during training such as learning rate, batch size, and the like.

At step 304, the method 300 includes selecting, by the processor 106, a prediction algorithm for the appropriate Artificial Intelligence (AI)-based prediction module 204. This involves section using a prediction model section and multiple regression based on the extracted plurality of features. The plurality of features includes at least one of model architecture details, a training dataset size and diversity, a training duration and computational resources, model complexity, training efficiency and hardware capabilities and hyperparameters used during training.

At step 306, the method 300 includes training, by the processor 106, the appropriate Artificial Intelligence (AI)-based prediction module 204 with the selected algorithm. This involves training using a prediction model.

At 308, the method 300 includes evaluating, by the processor 106, test prediction module's performance based on a test set using an appropriate metrics.

The evaluation results include adding new features or removing irrelevant ones. The evaluation results further include trying different model architectures or algorithms. The evaluation results include incorporating feedback loops from real-world model deployments.

At step 310, the method 300 includes obtaining, by the processor 106, all parameters from the plurality of data sources 104.

At step 312, the method 300 includes detecting, by the processor 106, parameter dependency of each parameter with one another to obtain input design parameters. This involves using a parameter dependency detection module to detect the parameter dependency of all parameters. The input design parameters include a size of dataset, a data accuracy (for example error counts), a model size, a learning rate, a batch size, and an Epochs 314-316.

At step 318, the method 300 includes evaluating, by the processor 106, the predicted algorithm using performance metric, and the input design parameters on the appropriate Artificial Intelligence (AI)-based prediction module 204.

The performance metric includes a perplexity, accuracy, F1 score, BLEU score, and a ROUGE score 326.

At step 320, the method 300 includes sending, by the processor 106, the performance evaluation of the appropriate Artificial Intelligence (AI)-based prediction module 204 to the user device 114.

At step 322, the method 300 includes releasing, by the user device 114, the appropriate Artificial Intelligence (AI)-based prediction module's 204 performance predication to real world application to guide development of new LLMs by predicting their performance early in a design phase.

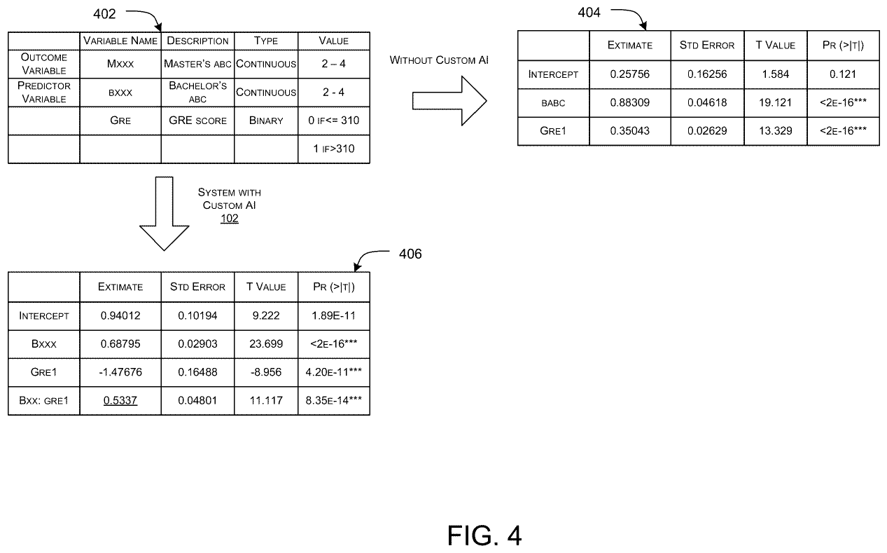

FIG. 4 is an example tabular representation of error detection results with and without a performance prediction algorithm, in accordance with embodiments of the present disclosure. The results 400 show tables with 404 or without 406 performance prediction algorithm using table 402. This figure outlines a performance prediction model, specifically focused on how certain variables interact to predict an outcome. In this FIG. 4, three variables: Mxxx (Outcome Variable), bxxx (Predictor Variable), and gre (another Predictor Variable) may be disclosed. Mxxx and bxxx may be continuous variables (ranging from 2 to 4), while gre may be a binary variable (0 if GRE score may be ≤310, 1 if GRE score may be >310). The custom AI model 406 processes these inputs to generate predictions. The variables may be used in a regression analysis, where their interaction terms and main effects may be examined. The model's estimates, standard errors, t-values, and p-values may be displayed. The interaction between bxxx and gre may be statistically significant, justifying its inclusion in the model.

For example, an interaction term may be statistically significant at the 5% significance level (as the p-value may be <0.05), which justifies the inclusion of the interaction term in the LLM model.

$$\begin{matrix}If , gre = 0 mxxx = b 0 + b 1 * bxxx + b 2 * gre + b 3 * bxxx * gre + error , & equation ( 35 ) \\ then : mxxx = 0.94 + 0.688 * bxxx - 1.477 * gre + 0.534 * bxxx * gre and & equation ( 23 ) \\ mxxx = 0.94 + 0.688 * bxxx - 1.477 * 0 + 0.534 * bxxx * 0 = 0940 + 0.688 * bxxx . & equation ( 36 )\end{matrix}$$

Further, if

$$fre = 1 , mxxx = 0.94 + 0.688 * bxxx - 1.477 * 1 + 0.534 * bxxx * 1 = - 0.537 + 1.222 * bxxx . \qquad equation ( 37 )$$

The coefficient of the interaction term (i.e.,bxxx: gre1) in R output displays the difference in slope between the two lines (i.e., 1.222−0.688=0.534). Where mxxx\text{mxxx}mxxx is the dependent variable (the outcome that is being predicted), β0\beta_0β0 is the intercept (the expected value of mxxx\text{mxxx}mxxx when all predictors are zero), β1\beta_1β1 is the coefficient for the variable bxxx\text{bxxx} bxxx, representing its main effect on mxxx\text {mxxx}mxxx, β2\beta_2β2 is the coefficient for the variable gre\text{gre} gre, representing its main effect on mxxx\text{mxxx}mxxx, β3\beta_3β3 is the coefficient for the interaction term bxxx×gre\text{bxxx} \times \text{gre}bxxx×gre, representing the combined effect of bxxx\text{bxxx}bxxx and gre\text{gre}gre on mxxx\text{mxxx}mxxx, the term error\text{error}error represents the random error or residuals, which capture the variability in mxxx\text{mxxx}mxxx.

In an example embodiment, interaction term: the interaction term β3×(bxxx×gre)\beta_3\times (\text{bxxx} \times \text{gre})β3×(bxxx×gre) allows the effect of bxxx\text{bxxx}bxxx on mxxx\text{mxxx}mxxx to depend on the level of gre\text{gre}gre. In other words, the impact of bxxx\text{bxxx}bxxx on mxxx\text{mxxx}mxxx changes when gre\text{gre}gre changes.

When gre=0\text{gre}=0gre=0. If gre=0\text{gre}=0, gre=0, the interaction term bxxx×gre\text{bxxx} \times \text{gre}bxxx×gre will also be zero. The equation simplifies to:

$$\begin{matrix}mxxx = β0 + β1 \times bxxx \times 0 + β3 \times ( bxxx \times 0 ) + error \backslash text \{ mxxx \} = \backslash {beta}_{0} + \backslash {beta}_{1} \backslash times \backslash text \{ bxxx \} + \backslash {beta}_{2} \backslash times 0 + \backslash {beta}_{3} \backslash times ( \backslash text \{ bxxx \} \backslash times 0 ) + \backslash text \{ error \} mxxx = β0 + β1 \times bxxx + β2 \times 0 + β3 \times ( bxxx \times 0 ) + error & equation ( 38 ) \\ mxxx = β0 + β1 \times bxxx + error \backslash text \{ mxxx \} = \backslash {beta}_{0} + \backslash {beta}_{1} \backslash times \backslash text \{ bxxx \} + \backslash text \{ error \} mxxx = β0 + β1 \times bxxx + error & equation ( 39 )\end{matrix}$$

In this simplified equation, the effect of bxxx\text{bxxx}bxxx on mxxx\text{mxxx}mxxx may be influenced by β1\beta_1β1, as both the main effect of gre\text{gre}gre and the interaction term are nullified.

When gre=0\text{gre}=0gre=0, the equation describes a simple linear relationship between bxxx\text{bxxx}bxxx and mxxx\text{mxxx}mxxx, without any contribution from gre\text{gre}gre. If gre≠0\text{gre} \neq 0gre=0, the interaction term would come into play, potentially altering the effect of bxxx\text{bxxx}bxxx on mxxx\text{mxxx}mxxx based on the value of gre\text{gre}gre.

Sample dataset with variables mxxx\text{mxxx}mxxx, bxxx\text{bxxx}bxxx, and gre\text{gre}gre are considered. A simple linear regression model (y=mx+by=mx+by=mx+b) . . . equation (40) is fit where the interaction may be ignored. A linear regression model is fit with an interaction term. Both models showing the fit and coefficients are compared. In such a scenario, a sample Dataset is first generated. Then, a small dataset with 10 observations is created.

TABLE 6

| bxxx\text{bxxx}bxxx | gre\text{gre}gre | mxxx\text{mxxx}mxxx |
|---|---|---|
| 1 | 10 | 15 |
| 2 | 20 | 30 |
| 3 | 30 | 45 |
| 4 | 10 | 28 |
| 5 | 20 | 52 |
| 6 | 30 | 70 |
| 7 | 10 | 45 |
| 8 | 20 | 65 |
| 9 | 30 | 90 |
| 10 | 10 | 70 |

In the next step, a Simple Linear Regression Model is fitted as below.

The equation for simple linear regression is:

$$mxxx = β0 + β1 \times bxxx + error \backslash text \{ mxxx \} = \backslash beta\_ 0 + \backslash beta\_ 1 \backslash times \backslash text \{ bxxx \} + \backslash text \{ error \} mxxx = β0 + β1 \times bxxx + error \qquad equation ( 41 )$$

In further next step, a Linear Regression Model with Interaction Term is fitted. The equation with the interaction term is:

$$mxxx = β0 + β1 \times bxxx + β2 \times gre + β3 \times ( bxxx \times gre ) + error \backslash text \{ mxxx \} = \backslash {beta}_{0} + \backslash {beta}_{1} \backslash times \backslash text \{ bxxx \} + \backslash {beta}_{2} \backslash times \backslash text \{ gre \} + \backslash {beta}_{3} \backslash times ( \backslash text \{ bxxx \} \backslash times \backslash text \{ gre \} ) + \backslash text \{ error \} mxx = β0 + β1 \times bxxx + β2 \times gre + β3 \times ( bxxx \times gre ) + error \qquad equation ( 42 )$$

Furthermore, the coefficients for both models are computed and a comparison table is created. Below is an example comparison table between the simple linear regression model and the interaction model:

TABLE 7

| | | bxxx | gre | Interaction | |
|---|---|---|---|---|---|
| | Intercept | Coefficient | Coefficient | Coefficient | R- |
| Model | (β0) | (β1) | (β2) | (β3) | squared |
| Simple Linear | 14.87 | 6.57 | N/A | N/A | 0.7452 |
| Regression | | | | | |
| Interaction | −2.34 | 5.32 | 0.93 | 0.0608 | 0.9861 |
| Model | | | | | |

The intercept β0\beta_0β0 is 14.87, and the coefficient for bxxx\text{bxxx}bxxx is 6.57. The R-squared value is 0.7452, indicating that this model explains about 74.52% of the variance in mxxx\text{mxxx}mxxx. For the interaction model, the intercept β0\beta_0β0 is −2.34. The coefficient for bxxx\text{bxxx}bxxx is 5.32, slightly lower than in the simple model. The coefficient for gre\text{gre}gre is 0.93, and for the interaction term, it is 0.0608. The R-squared value is 0.9861, showing that this model explains about 98.61% of the variance in mxxx\text{mxxx}mxxx.

Therefore, it may be inferred that an interaction model fits the data much better (higher R-squared) compared to the simple linear regression, which suggests that the interaction between bxxx\text{bxxx}bxxx and gre\text{gre}gre is indeed important for explaining mxxx\text{mxxx}mxxx. The presence of the interaction term significantly improves the model's accuracy in predicting.

FIG. 4 depicts a statistical analysis aimed at predicting a performance outcome (likely academic or professional). The system 102 may utilize a custom AI model to examine the relationship between various predictor variables and the outcome. This section 404 displays the results of a traditional statistical model. It includes estimate which refers to estimated coefficient for each predictor variable. A Std Error refers to the standard error of the estimate. The t value refers to the t-statistic for testing the significance of the coefficient. A Pr(>|t|) refers to the p-value associated with the t-test.

In the custom AI model 406, the model includes an interaction term between bxxx and gre to capture their combined effect on the outcome. The interaction term may be found to be statistically significant at the 5% level, justifying its inclusion. The model equations may be presented as above for when gre is 0 and when gre may be 1, revealing how the interaction term influences the relationship between bxxx and the outcome. The coefficient of the interaction term (bxxx: greI) represents the difference in slope between the two lines (when gre may be 0 vs. 1). The figure shows how the outcome variable Mxxx may be calculated depending on the value of gre (0 or 1). The coefficients indicate how the predictor variable bxxx influences Mxxx differently depending on the GRE score (interaction term). Overall, this figure demonstrates how a custom AI model, incorporating an interaction term, may enhance prediction accuracy compared to a traditional statistical model.

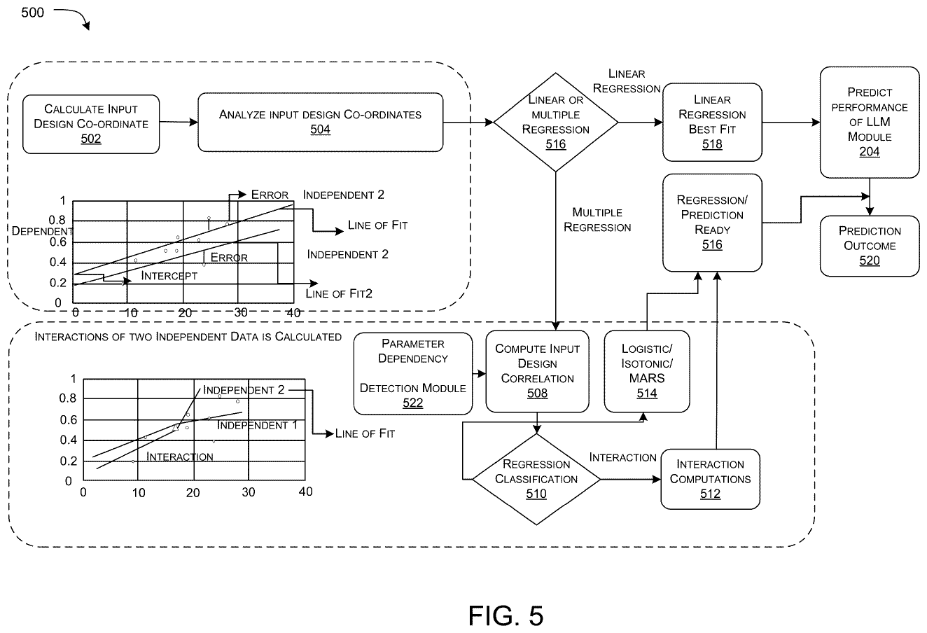

FIG. 5 is a process 500 flowchart illustrating an exemplary process of predicting model performance using a customized Artificial Intelligence (AI) technique, in accordance with embodiments of the present disclosure.

At step 502, the process 500 includes calculating, by the processor 106, input design co-ordinates.

At step 504, the process 500 includes analyzing, by the processor 106, the input design co-ordinates. This involves identifying all the dependent and independent variables. This may involve processor 106 performing either a linear or multiple regression analysis to determine the one or more appropriate fit for the data. During analysis relationships between input variables may be computed, crucial for understanding how variables interact.

For example, the relationships between the dependent and the one or more independent variables may include one or more errors, one or more intercepts (b), and slope (m). The one or more appropriate fit for the data may be calculated using:

$$Y = c + ax 1 + bx 2 + error \qquad equation ( 43 )$$

At step 506, the process 500 includes checking, by the processor 106, linear or multiple regression. The prediction eligibility check data points support on linear or multiple regression. Both simple and multiple linear regression may be used to establish initial relationships between input variables and the outcome.

At step 508, the process 500 includes detecting, by the processor 106, parameter dependency. The detection helps in identifying how parameters influence the model's performance.

Further, the process 500 includes computing, by the processor 106, the input design co-relation. If the data points are co-related for multiple regression, analyze the input design co-ordinates.

At step 510, the process 500 includes performing, by the processor 106, the regression classification.

For example, interactions of two independent data may be calculated using below:

$$Y = c + ax 1 + bx 2 + d ( x 1 \times x 2 ) + error \qquad equation ( 44 )$$

At step 512, the process 500 includes performing, by the processor 106, interaction computations. If the data points are co-related for multiple regression, analyze the input design co-ordinates.

At step 514, the process 500 includes providing, by the processor 106, regression or prediction ready to the appropriate Artificial Intelligence (AI)-based prediction module 204. If regression is eligible for polynomial/isotonic and the like. The processor 106 computes the details for regression.

At step 516, the process 500 includes providing, by the processor 106, predictions.

At step 518, the process 500 includes providing, by the processor 106, linear regression appropriate fit. For interaction with regression, the appropriate Artificial Intelligence (AI)-based prediction module 204 performs the prediction and provide the outputs. The interactions include an interaction occurs when an independent variable has a different effect on the outcome depending on the values of another independent variable. The least square may be a parameter estimation method in regression analysis based on minimizing the sum of the squares of the residuals or errors.

At step 520, the system 102 provides the prediction outcomes of the appropriate Artificial Intelligence (AI)-based prediction module 204. This may involve adding new features or removing irrelevant ones. Trying different model architectures or algorithms. Incorporating feedback loops from real-world model deployments.

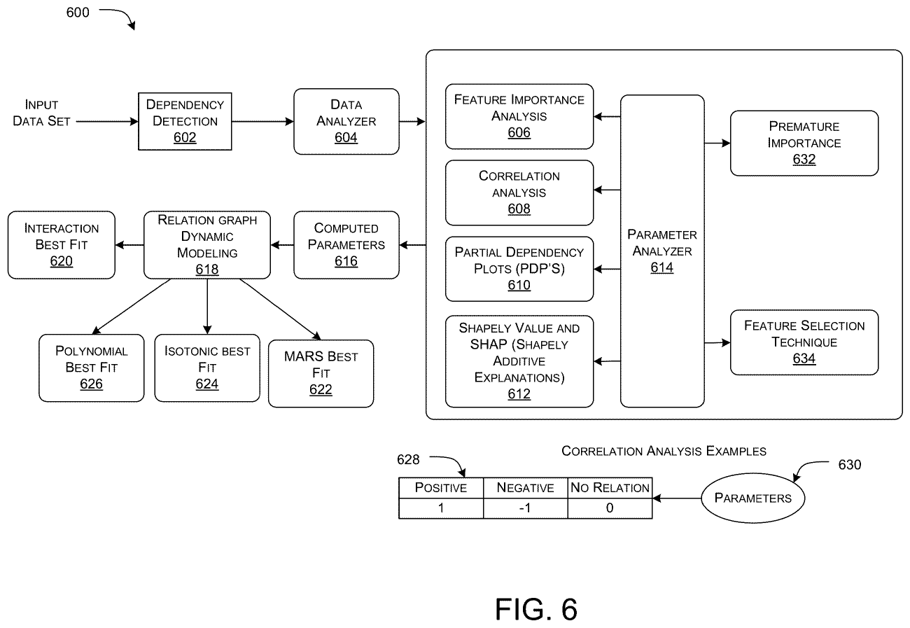

FIG. 6 is a block diagram representation illustrating an exemplary process 600 of determining parameter dependency of datasets, in accordance with embodiments of the present disclosure.

The process 600 includes receiving, by the processor 106, the input dataset.

At step 602, the process 600 includes performing, by the processor 106, dependency detection. This involves parameter analyzer. The parameter analyzer may extract parameters from the dataset and identify dependencies between them. This may involve relation graph. The relation graph visualizes relationships between parameters. This may further involve dynamic modelling. The dynamic modelling analyzes non-linear relationships using techniques such as MARS (Multivariate Adaptive Regression Splines) and isotonic regression.

At step 604, the process 600 includes analyzing, by the processor 106, the data.

At step 606, the process 600 includes performing, by the processor 106, feature importance analysis. This involves permutation Importance. This involves assesses feature importance by shuffling feature values and observing impact on model performance. This involves decision tree, random forest, this involves gradient boost. The gradient boost utilizes the algorithms to identify high-impact features.

At step 608, the process 600 includes performing, by the processor 106, correlation analysis. The correlation analysis includes Pearson, spearman, and Kendall. The correlation analysis calculates correlation coefficients to measure linear and non-linear relationships between features.

At step 610, the process 600 includes performing, by the processor 106, the data analysis using partial dependency plots (PDP's).

At step 612, the process 600 includes performing, by the processor 106, the data analyzing using Shapley Values and SHAP (SHapley Additive exPlanations).

At step 614, the process 600 includes analyzing, by the processor 106, parameter. This involves extracting significant parameters based on dependency and correlation analysis.

At step 616, the process 600 includes sending, by the processor 106, computed parameters to a relation graph dynamic modelling.

At step 618, the process 600 includes receiving, by the relation graph dynamic modelling, the computed parameters.

At step 620, the process 600 includes identifying, by the processor 106, feature selection techniques. This involves Partial Dependency Plots (PDP) to visualizes the impact of a feature on the model's prediction. This involves recursive feature elimination. The recursive feature elimination Iteratively removes less important features. This involves L1 and L2 regularization. L1 and L2 regularization includes penalizes model complexity to prevent overfitting.

This involves model selection. The model selection may select the appropriate-fit regression model based on the analyzed data and feature importance. This involves Shapley Values and SHAP. Shapley Values and SHAP Identifies key features influencing the target variable and their contribution to predictions. This involves relation graph. The relation graph visualizes parameter dependencies and interactions.

At step 622-626, the process 600 includes providing, by the processor 106, at one of polynomial appropriate fit, isotonic appropriate fit, and MARS appropriate fit.

For example, correlation analysis includes demonstrating how correlation coefficients (positive, negative, or no correlation) 628 represent the strength and direction of relationships between features. This involves data preparation. The data preparation includes analyzing the input dataset for dependencies, correlations, and feature importance. This involves model building. The model building includes constructing a custom algorithm considering interactions, non-linear relationships, and feature selection. This involves model evaluation. The model evaluation uses techniques such as Shapley values and PDPs to understand model behavior and feature impact.

This may involve identifying the importance of understanding parameter dependencies and interactions for building effective prediction models. This may involve highlighting the use of various statistical and machine learning techniques for data analysis and model development. This may involve iterative process, allowing for refinement based on model performance.

In an exemplary embodiment, the shapely Values and SHAP (SHapley Additive exPlanations) features with large absolute Shapley values #imay be considered important means required for prediction. For example:

$$ϕ i = S ⊆ N \backslash \{ i \} Σ \vert N \vert ! \vert S \vert ! ( \vert N \vert - \vert S \vert - 1 ) ! ( v ( S ⋃ \{ i \} ) - v ( S ) ) , \qquad equation ( 45 )$$

where N may be the set of all features (players), SS may be a subset of features that does not include feature ii, v(S) v(S) may be the value (game outcome, prediction) of subset SS, and φi may be the Shapley value for feature i.

In an exemplary embodiment, for example, correlation analysis includes positive value 0, negative value −1, and no relation 1. Further, a value between −1 and 1, indicates the strength and direction of the linear relationship. A correlation of 1 refers to a perfect positive relationship, −1 indicates a perfect negative relationship, and 0 suggests no linear relationship.

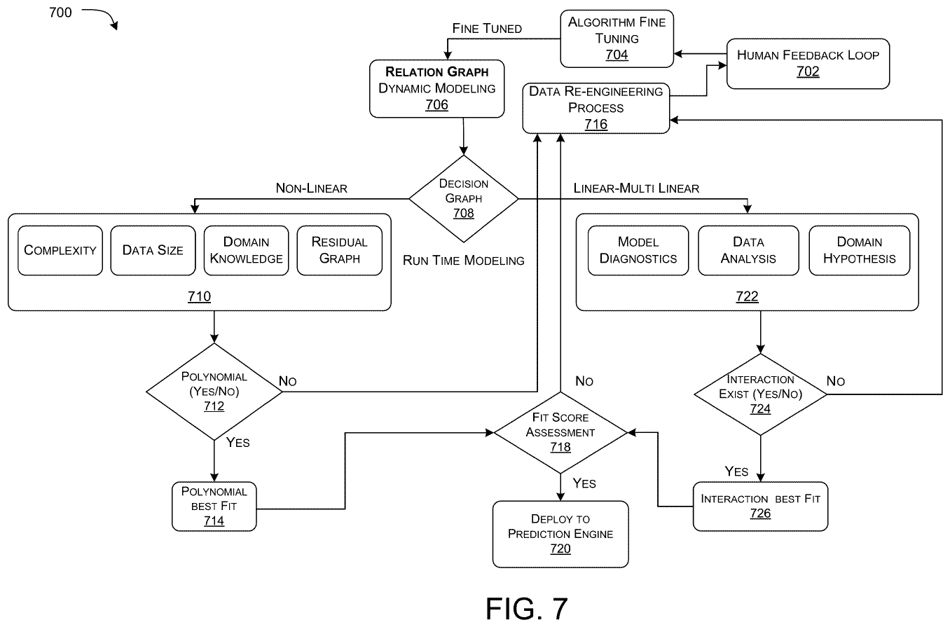

FIG. 7 is a flowchart illustrating an exemplary method 700 of dynamically selecting an appropriate Artificial Intelligence (AI)-based prediction model from among a plurality of Artificial Intelligence (AI)-based prediction models based on the extracted plurality of features, in accordance with embodiments of the present disclosure.

At step 702, the method 700 includes receiving, by the processor 106, human feedback loop.

At step 704, the method 700 includes providing, by the processor 106, algorithm fine tuning.

At step 706, the method 700 includes providing, by the processor 106 relation graph dynamic modeling based on fine-tuned data.

At step 708, the method 700 includes providing, by the processor 106, decision graph with non-linear and linear-multi linear data. This involves the non-linear includes complexity, data size, domain knowledge, and residual graph of the datasets 710. This involves the linear-multi linear data includes model diagnostics, data analysis, and domain hypothesis 722.

At step 712, the method 700 includes checking, by the processor 106, if the non-linear data may be polynomial. This involves checking If the residuals display a curve—there need a high degree polynomial to appropriate fit. This involves checking if dataset size may be more, the system 102 adapts quickly the polynomial. The domain knowledge also helps decide to go for polynomial. Higher the complexity in the non-linearity led to go for polynomial.

At step 714, the method 700 includes providing, by the processor 106, polynomial appropriate fit.

At step 716, the method 700 includes providing, by the processor 106, data re-engineering process if the non-linear data may not polynomial.

At step 718, the method 700 includes providing, by the processor 106, provides fit score assessment based on the polynomial appropriate fit.

At step 720, the method 700 includes deploying, by the processor 106, the performance algorithm to the prediction engine if the fit score assessment is true.

At step 724, the method 700 includes checking, by the processor 106, if there is an interaction. This involves domain hypothesis; subject matter suggests that two variables might work together to influence the outcome in a specific way. This involves checking if exist complex relations. This involves checking if exist lack of fit, unusual residual pattern. This involves checking if prediction don't capture complexity of relationship.

At step 726, the method 700 includes providing, by the processor 106, an interaction appropriate fit to the module 206.

In an exemplary embodiment, before fine tuning the model, the data sets may be fed as an input to performance prediction model to obtain the details of predicted performance. The predicted performance may be used of the selected data sets on specific LLM's to be used such that developers may design and implement LLM powered applications by avoiding the iteration processes by taking care of all the optimization procedures before evaluating the model performance like F1 score on the model outcomes which significantly reduces the iteration process developers.

In an exemplary embodiment, if the residuals display a curve, then the processor 106 may apply a high degree polynomial to appropriate fit. If dataset size is large, then the processor 106 adapts quickly the polynomial appropriate fit. The domain knowledge also helps decide whether to go for polynomial appropriate fit or not. Higher the complexity in the non-linearity led to calculating polynomial appropriate fit.

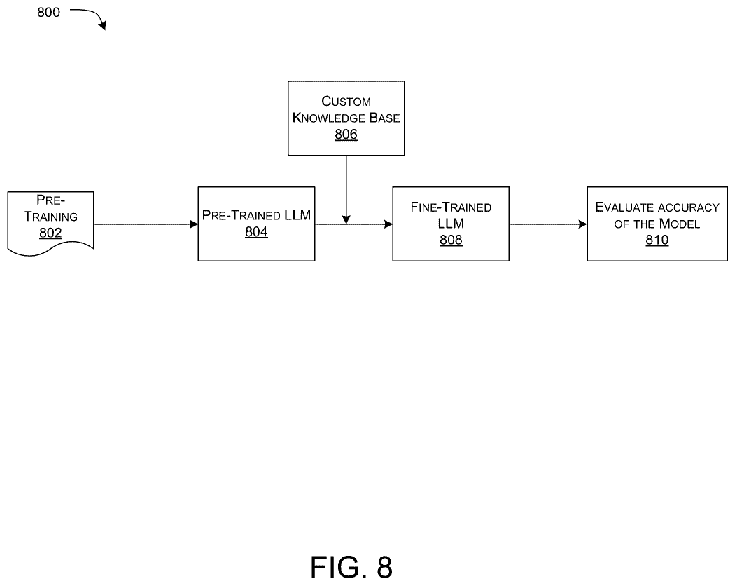

FIG. 8 illustrates a schematic representation of fine-tuning process along with iterations to optimize a model performance, in accordance with the embodiments of the present disclosure. The method 800 includes pre-training a model using a dataset 802 to generate a pre-trained LLM 804, Further, the pre-trained LLM 804 may be used along with a custom knowledge base 806 to generate a fine-trained LLM 808.

In an exemplary embodiment, for example, building LLM powered applications, the user device 114 first select an LLM model and start training the model from scratch or modifying an existing one. In many cases, adapting a pre-existing model may be efficient, however some instances may require fine-tuning with a new model. After the user device 114 may prepare the model with the data through fine tuning process, the system 102 assess its performance. If the fine-tuning process may be unsatisfactory, then the system 102 tries to optimize the input data by adding additional domain information or context required for fine turning. The whole process may be iterative to ensure the model's outputs may be in synchronous with human preferences with level of accuracy needed for application outputs.

In an exemplary embodiment, the processor 106 may evaluate the accuracy of the model. The evaluation may include conducting evaluations regularly using metrics and benchmarks. The Iteration may be between prompt engineering, fine-tuning, and evaluation until reach the desired outcomes.

In an exemplary embodiment, once the model performs as expected the system 102 may be deployed in a real world to optimize for computational efficiency and user experience.

In an exemplary embodiment, the LLM fine tuning may be a process of taking pre-trained models and further training them on smaller, specific datasets to refine their capabilities and improve performance in a particular task or domain. Fine-tuning may be related to turning general-purpose models and turning them into specialized models.

In an exemplary embodiment, the system 102 may evaluate the fine-tuned model's performance on unseen data to determine its effectiveness for sample tasks. The evaluation may involve metrics, accuracy, precision, recall, or F1 score depending on the specific task. If F1 score >0.9 may be considered excellent. A score between 0.8 and 0.9 may be considered good, while a score between 0.5 to 0.8 may be considered average. If the F1 score falls below 0.5, then the model may be considered to have a poor performance.

In an example embodiment, fine-tuning a large language model (LLM) may involve adapting a pre-trained model to a specific task or domain using a smaller, task-specific dataset. This process generally includes training, evaluating with metrics like F1 score, and iteratively improving the model. First, a dataset is selected, the base LLM Model may be trained by using training datasets. Once the model is trained, the performance of the model is evaluated for new data to perform the prediction (one of the examples) by calculating the F1 score.

In one example embodiment, while fine-tuning a pre-trained LLM for a binary text classification task, customer reviews are classified as either “positive” or “negative.” To fine-tune a model using a BERT architecture, the first step involves preparing the validation data, which in this case includes examples such as “Great quality and fast shipping.” labeled as “positive” and “Not what I expected, very poor quality.” labeled as “negative.” After preparing the validation data, the process continues with loading a pre-trained model and tokenizer using the BERT base version, “Bert-base-uncased,” from the Transformers library. The data is then tokenized, where each text example is converted into a format suitable for input into the model, with padding and truncation applied to ensure uniformity in input length.

Further, the training and validation datasets are prepared. Labels are encoded as binary values, with “negative” labeled as 0 and “positive” as 1. These encoded texts and labels are then combined into datasets using a custom Reviews Dataset class that handles the input encoding and provides access to each data item.

Training arguments are defined to configure the fine-tuning process, specifying parameters such as the number of training epochs, batch sizes, warmup steps, and weight decay. A Trainer object is initialized with the model, training arguments, and the prepared datasets. The model is then fine-tuned on the training data, and evaluation is conducted after each epoch. Post-training, the model's performance is evaluated using the F1 score, particularly useful for imbalanced datasets. Predictions on the validation set are generated, and the F1 score is calculated using the f1_score function from the library. The F1 score, which measures the balance between precision and recall, is then printed to assess the model's effectiveness.

In the iterative fine-tuning process, if the F1 score is unsatisfactory, several strategies may be employed to improve the model's performance. These include data augmentation, which involves increasing the amount of training data, particularly for underrepresented classes; hyperparameter tuning, where adjustments are made to the learning rate, batch size, or number of epochs; and advanced techniques, such as implementing weighted loss functions, ensemble methods, or adding regularization. Another approach is domain-specific pre-training, where the model is pre-trained on a domain-specific corpus before fine-tuning. For example, hyperparameter tuning may be applied by adjusting parameters like the learning rate, increasing the number of epochs, or modifying the batch size.

During the iterative process, it is crucial to monitor the model to prevent overfitting by comparing its performance on the training and validation sets. Early stopping may be implemented to halt training when the validation score ceases to improve, and cross-validation may be used to ensure the model generalizes well across different subsets of the data. By iterating through these techniques, the model's performance may be progressively enhanced until it reaches a satisfactory level.

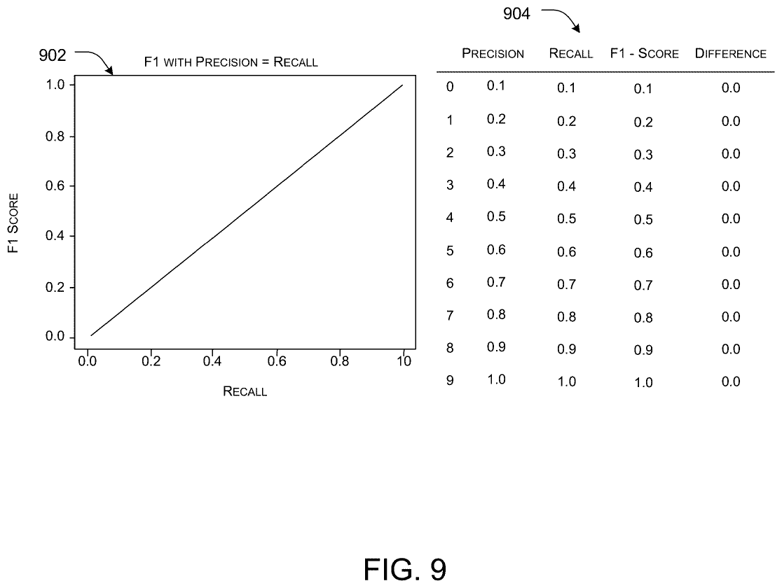

FIG. 9 illustrates an example graphical and tabular representation of a F1 score at a plurality of precision and recall values, in accordance with the embodiments of the present disclosure. The example graphical and tabular representation includes F1 score graph 902 a table 904. The table includes variables such as precision, recall, F1-score, and difference values corresponding to the graph 902.

In an exemplary embodiment, the F1-score may be a measure of a language model's balance between precision and recall or harmonic mean of precision and recall or Evaluation metric that measure model's accuracy.

F1-score=2(precision×recall)/(precision+recall) equation (46)

Where precision: number of true positives. Recall: number of true positives divided by the number of true positives plus false negatives, True Positives (TP): Number of samples correctly predicted as “positive.” False Positives (FP): Number of samples wrongly predicted as “positive.” True Negatives (TN): Number of samples correctly predicted as “negative.” False Negatives (FN): Number of samples wrongly predicted as “negative.”

Precision=TP/TP+FP, Recall=TP/TP+FN equation(47)

In an exemplary embodiment, to obtain better F1 score, the system 102 may perform the iteration process making minor adjustments to a model's parameters or architecture to improve the model's performance on specific tasks. F1 score shows lack of context data or prompt re-designing or higher tokens to process, which eventually also need higher GPU and computational resources. Based on the validation and test sets results, need to make further adjustments to the model's architecture, hyperparameters, or training data to improve its performance. The iterative process in fine tuning developers know the data set to use for finetuning but before they deploy them to LLM, first they may apply the data set into performance predictor model to check performance the system 102 may produce. This may allow developers to do design changes.

In an exemplary embodiment, table1 shows how efficiency may be improved comparing as is regression algorithm against the system 102 algorithm with the integration of dynamic modelling generated based on the nature of data set it learns during application of custom algorithm.

TABLE 8

| Data Sets | As Is Regression | Custom Algorithm of |
|---|---|---|
| (Different | Processing | system |
| Sizes) | Time (Hrs.) | Processing Time (Hrs.) |
| Data Set 1 | 5 | 3 |
| Data Set 2 | 3 | 2 |
| Data Set 3 | 10 | 7 |

In an exemplary embodiment, table 2 shows how development of LLM fine tuning improves its efficiency by reducing the iterations to achieve the necessary performance accuracy by using the performance prediction models to obtain details and apply the design changes they train on the data set and at the LLM platform.

TABLE 9

| | Training | Training | |
|---|---|---|---|
| | Iterations | Iterations | |
| | (Before | (After | |
| Data Sets | Performance | Performance | Efficiency (%) |
| (Different Sizes) | Prediction) | Prediction) | Improvements |
| Data Set 1(low | 8 | 5 | 30% |
| complex) | | | |
| Data Set 2(Medium | 10 | 7 | 25-30% |
| complex) | | | |
| Data Set 3 (High | 15 | 11 | 25% |
| Complex) | | | |

Sample data sets may be given as input to performance predictor module, which includes of custom algorithm integrated with collection of regression models. During the process of model training through this model, model may be designed dynamically based on the analysis of data sets the system 102 performs used for the training.

In an exemplary embodiment, all the parameters of data set may be analyzed by the custom AI algorithm. The system 102 performs parameter analysis through analyzer module to gain analysis of parameter dependency. The system 102 designs the dynamic model based on computed parameters and their relationship with dependency knowledge graph created during parameter analysis in the previous step. The system 102 may apply the custom algorithm for creation of dynamic model. The dynamic model may be trained on newly designed Custom AI Algorithm with data set. The AIs may be regression algorithm if it's applied to train the model with the input data set. The system goes with iterations with post regression algorithm performance try to find the appropriate fit and also evaluate its performance until achieve expected desired level of accuracy which result in usage of more or high computational resources like GPU's and memory of the processing units during this iteration process.

In an exemplary embodiment, the system 102 may provide a custom solution which gives the appropriate line of fit which helps to give appropriate prediction for avoiding the additional cost incurred with repetitive approaches by developers in case of failures. The solution has the specific way of computing the prediction of LLM performance to process the large data sets used for training the models before deploying them in the production. The system 102 specific way of calculation on performance required to process the large data sets to avoid the iterations by developers. The system 102 prediction approach enables predictive accuracy. The system 102 may predict how well an LLM may perform on specific tasks, considering factors such as the nature of the task, the size of the model, and the data it was trained on.

In an exemplary embodiment, the system 102 may allow for better planning and resource allocation. The system 102 performance predictiveness of LLM's based on data quality, document artifacts for training and prompt engineering work. The system 102 may identify and assess the gap to rollout the model. The system 102 integrates of multiple metrics or prioritizes them according to specific application requirements. The performance predictor for Large Language Models (LLMs) offers several benefits, particularly in enhancing efficiency, reliability, and user experience in various applications.

In an exemplary embodiment, the system 102 may provide increased reliability of application leads to reduced iterations used by the developers across post deployment cycles. The system 102 provides models may be assessed accurately for the readiness of the model rollout with fit for the purpose. The prediction algorithm and continued fine-during process, reduces the iteration processes.

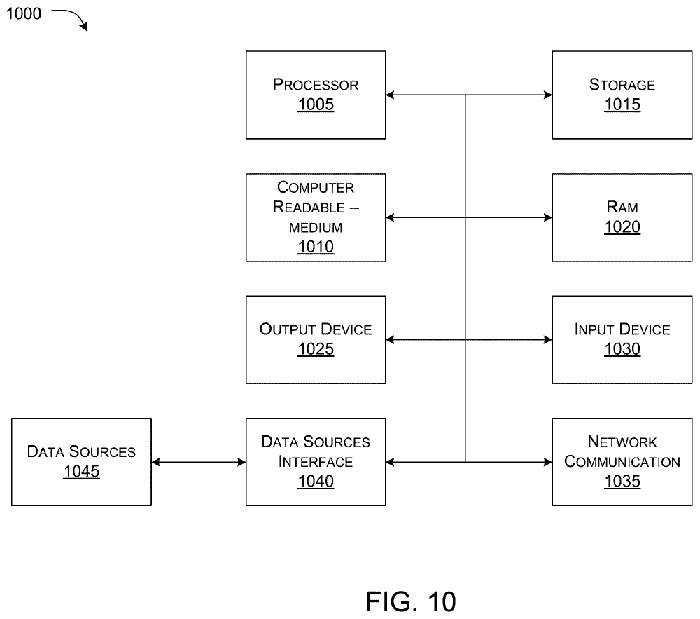

FIG. 10 is an exemplary block diagram representation of a hardware platform for implementation of the disclosed system, in accordance with embodiments of the present disclosure. For the sake of brevity, the construction, and operational features of the system 102 which may be explained in detail above may not explained in detail herein. Particularly, computing machines such as but not limited to internal/external server clusters, quantum computers, desktops, laptops, smartphones, tablets, and wearables may be used to execute the system 102 or may include the structure of the hardware platform 1000. As illustrated, the hardware platform 1000 may include additional components not shown, and some of the components described may be removed and/or modified. For example, the system 102 with multiple GPUs may be located on external-cloud platforms including Amazon Web Services® (AWS), internal corporate cloud computing clusters, or organizational computing resources.

The hardware platform 1000 may be a computer system such as the system 102 that may be used with the embodiments described herein. The computer system may represent a computational platform that includes components that may be in a server or another computer system. The system 102 may be executed by the processor 1005 (for example, single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (example, random access memory (RAM), read-only memory (ROM), erasable, programmable ROM (EPROM), electrically erasable, programmable ROM (EEPROM), hard drives, and flash memory). The system may include the processor 1005 that executes software instructions or code stored on a non-transitory computer-readable storage medium 1015 to perform methods of the present disclosure. The software code includes, for example, instructions to gather data and analyze the data.

The instructions on the computer-readable storage medium 1015 may be read and stored the instructions in storage 1010 or random-access memory (RAM) 1020. The computer-readable storage medium 1015 may provide a space for keeping static data where at least some instructions could be stored for later execution. The stored instructions may be further compiled to generate other representations of the instructions and dynamically stored in the RAM such as RAM 1020. The processor 1005 may read instructions from the RAM 1020 and perform actions as instructed.

The system 102 may further include the output device 1025 to provide at least some of the results of the execution as output including, but not limited to, visual information to users, such as external agents. The output device 1025 may include a display on computing devices and virtual reality glasses. For example, the display may be a mobile phone screen or a laptop screen. GUIs and/or text may be presented as an output on the display screen. The system 102 may further include an input device 1030 to provide a user or another device with mechanisms for entering data and/or otherwise interacting with the system 102. The input device 1030 may include, for example, a keyboard, a keypad, a mouse, or a touchscreen. Each of these output devices 1025 and input device 1030 may be joined by one or more additional peripherals. For example, the output device 1025 may be used to display the results such as bot responses by the executable chatbot.

A network communicator 1035 may be provided to connect the system 102 to a network and in turn to other devices connected to the network including other clients, servers, data stores, and interfaces, for example. A network communicator 1035 may include, for example, a network adapter such as a LAN adapter or a wireless adapter. The system 102 may include a data sources interface 1040 to access the data source interface 1045. The data source interface 1045 may be an information resource. As an example, a database of exceptions and rules may be provided as the data source interface 1045. Moreover, knowledge repositories and curated data may be other examples of the data source interface 1045.

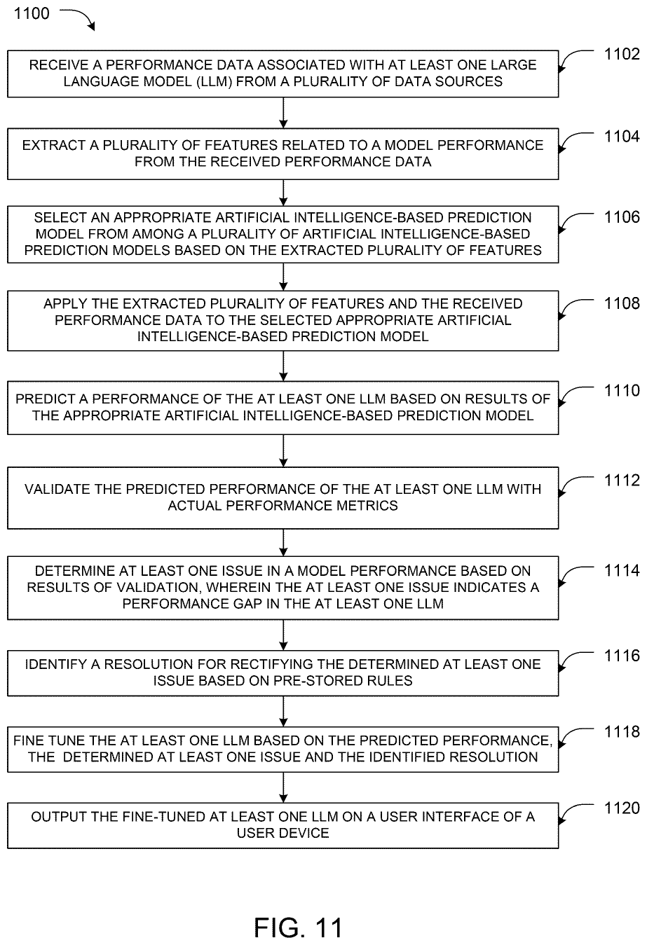

FIG. 11 is a flowchart illustrating an exemplary method for predicting performance of Large Language Models (LLMs), in accordance with embodiments of the present disclosure.

At step 1102, the method 1100 includes receiving, by the processor 106, a performance data associated with at least one large language model (LLM) from a plurality of data sources 104.

At step 1104, the method 1100 includes extracting, by the processor 106, plurality of features related to a model performance from the received performance data.

At step 1106, the method 1100 includes selecting, by the processor 106, an appropriate Artificial Intelligence (AI)-based prediction model from among a plurality of Artificial Intelligence (AI)-based prediction models based on the extracted plurality of features.

At step 1108, the method 1100 includes applying, by the processor 106, the extracted plurality of features and the received performance data to the selected appropriate Artificial Intelligence (AI)-based prediction model;

At step 1110, the method 1100 includes predicting, by the processor 106, a performance of the at least one LLM based on results of the appropriate Artificial Intelligence (AI)-based prediction model.

At step 1112, the method 1100 includes validating, by the processor 106, the predicted performance of the at least one LLM with actual performance metrics.

At step 1114, the method 1100 includes determining, by the processor 106, at least one issue in a model performance based on results of validation. The at least one issue indicates a performance gap in the at least one LLM.

At step 1116, the method 1100 includes identifying, by the processor 106, a resolution for rectifying the determined at least one issue based on pre-stored rules.

At step 1118, the method 1100 includes fine tuning, by the processor 106, the at least one LLM based on the predicted performance, the determined at least one issue and the identified resolution.

At step 1120, the method 1100 includes outputting, by the processor 106, the fine-tuned at least one LLM on a user interface of a user device 114.

The system and the traditional performance testing systems may be fundamentally different concepts. The system focuses on pre-deployment performance predictions for a dataset intended for fine-tuning a specific LLM. In contrast, the traditional performance testing systems addresses the testing of an LLM's performance post-development and deployment. This involves optimizing the LLM's performance through testing after it has been developed and deployed by developers.

In a pre-deployment phase, the system estimates the LLM's performance based on datasets that may be used for fine-tuning and deployment. This prediction process helps in selecting the most appropriate LLM. This involves predicting metrics such as perplexity or F1 score based on historical data of similar LLMs and applying a custom AI algorithm with dynamic modeling capabilities to obtain predicted performance scores. Tools used may include a custom AI algorithm integrated into the overall solution with business logic. This process is aimed at performance prediction using datasets, helping to avoid the complex iterative processes typically required post-deployment. No additional infrastructure is needed for performance detection, as it relies solely on historical performance data to forecast the LLM's performance.

The present method optimizes the fine-tuning process of Large Language Models (LLMs) by using a predictive performance engine. This engine may be designed to save resources and improve efficiency by predicting how well an LLM will perform with specific datasets before full-scale deployment and fine-tuning.

The system solution involves a performance predictor engine that may dynamically model the data and create custom algorithms to predict LLM performance. This engine enables developers to assess potential performance issues early in the development process, allowing them to make necessary adjustments to the data and fine-tuning process. The engine models the data by analyzing its complexity and extracting parameters and hyperparameters. The engine then builds a dynamic model that predicts the LLM's performance based on the specific dataset's complexity, allowing to anticipate and address performance issues before deployment. A key innovation may be, for example, to use Shapley values to assess the contribution of individual features to the model's predictions. Shapley values help in understanding the importance of each feature, ensuring the model may interpretable and transparent. The use of Shapley values may be crucial for understanding the contribution of each feature to the prediction outcome. This ensures that the model may not be accurate but also interpretable, allowing developers to make informed decisions about feature selection and model adjustments.

The process begins with data collection and feature engineering, followed by the creation of a prediction model using a combination of polynomial fit and linear regression techniques. The polynomial fit approach may be employed to capture non-linear relationships in the data, allowing the model to handle complex patterns more effectively. Meanwhile, linear regression may be used for simpler, more direct relationships. The combination of polynomial fit and linear regression enables the model to handle a wide range of data complexities. Polynomial fit may be particularly effective in capturing intricate patterns, while linear regression provides a straightforward approach for simpler datasets. The embodiments described herein disclose how these methods may be applied to different datasets, demonstrating the flexibility and robustness of the predictive engine.

The custom AI algorithm may be designed to adapt to the nature of the data, creating an appropriate-fit model that accurately predicts LLM performance. This algorithm may build dynamically at runtime, taking into account the data's complexity, parameter dependencies, and other critical factors. A significant part of the present invention is the error rate in LLM predictions. The custom algorithm shows a marked reduction in error rates compared to traditional methods, demonstrating its effectiveness.

The performance may be evaluated using metrics like perplexity, accuracy, F1 score, and error rate. The reduced error rate may be highlighted as a key benefit, indicating more precise predictions and fewer resources spent on incorrect model configurations. The performance of the LLM may be further evaluated using metrics such as perplexity, accuracy, and F1 score. The custom algorithm's output may be compared to traditional methods, showing improved accuracy and reduced error rates.

The custom algorithm's ability to adapt to different datasets and dynamically create prediction models may disclosed above through various examples. The process ensures that the LLM fine-tuning may be optimized for different levels of data complexity, conserving resources, and improving efficiency.

The custom algorithm's ability to adapt to different datasets and dynamically create prediction models may be demonstrated through various examples. The flexibility of the algorithm ensures that LLM fine-tuning may be optimized for different data complexities, conserving resources and improving efficiency.

The written description describes the subject matter herein to enable any person skilled in the art to make and use the embodiments. The scope of the subject matter embodiments may be defined by the claims and may include other modifications that occur to those skilled in the art. Such other modifications may be intended to be within the scope of the claims if they have similar elements that do not differ from the literal language of the claims or if they include equivalent elements with insubstantial differences from the literal language of the claims.

The embodiments herein may comprise hardware and software elements. The embodiments that may be implemented in software include but may not limited to, firmware, resident software, microcode, and the like. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components may be required. On the contrary, a variety of optional components may be described to illustrate the wide variety of possible embodiments of the disclosure. When a single device or article may be described herein, it may be apparent that more than one device/article (whether or not they cooperate) may be used in place of a single device/article. Similarly, where more than one device or article may be described herein (whether or not they cooperate), the system may be apparent that a single device/article may be used in place of the more than one device or article, or a different number of devices/articles may be used instead of the shown number of devices or programs. The functionality and/or the features of a device may be alternatively embodied by one or more other devices which may not explicitly described as having such functionality/features. Thus, other embodiments of the disclosure need not include the device itself.

The illustrated steps may be set out to explain the exemplary embodiments shown, and it should be anticipated that ongoing technological development may change the manner in which particular functions may be performed. These examples may be presented herein for purposes of illustration, and not limitation. Further, the boundaries of the functional building blocks have been arbitrarily defined herein for the convenience of the description. Alternative boundaries may be defined as long as the specified functions and relationships thereof may be appropriately performed. Alternatives (including equivalents, extensions, variations, deviations, and the like, of those described herein) may be apparent to persons skilled in the relevant art(s) based on the teachings contained herein. Such alternatives fall within the scope and spirit of the disclosed embodiments. Also, the words “comprising,” “having,” “containing,” and “including,” and other similar forms may be intended to be equivalent in meaning and be open-ended in that an item or items following any one of these words may not meant to be an exhaustive listing of such item or items or meant to be limited to the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It may therefore intend that the scope of the disclosure be limited not by this detailed description, but by any claims that issue on an application based here on. Accordingly, the embodiments of the present disclosure may be intended to be illustrative, but not limited, of the scope of the disclosure, which may be outlined in the following claims.

1. A system comprising:
a processor; and
a memory communicably coupled to the processor, wherein the memory comprises processor-executable instructions which, when executed by the processor, cause the processor to:
receive a performance data associated with at least one Large Language Model (LLM) from a plurality of data sources;
extract a plurality of features related to a model performance from the received performance data;
select an appropriate Artificial Intelligence (AI)-based prediction model from among a plurality of Artificial Intelligence (AI)-based prediction models based on the extracted plurality of features;
apply the extracted plurality of features and the received performance data to selected appropriate Artificial Intelligence (AI)-based prediction model;
predict a performance of the at least one LLM based on results of appropriate Artificial Intelligence (AI)-based prediction model;
validate the predicted performance of the at least one LLM with actual performance metrics;
determine at least one issue in a model performance based on the results of validation, wherein the at least one issue indicates a performance gap in the at least one LLM;
identify a resolution for rectifying the determined at least one issue based on pre-stored rules;
fine tune the at least one LLM based on the predicted performance, the determined at least one issue, and the identified resolution; and
output fine-tuned at least one LLM on a user interface of a user device.

2. The system of claim 1, wherein to predict the performance of the at least one LLM based on the results of appropriate Artificial Intelligence (AI)-based prediction model, the processor is configured to:
analyze a plurality of parameters comprised in the performance data to identify at least one of dependent variables and independent variables, wherein the plurality of parameters corresponds to input design parameters;
determine a parameter dependency for each of the plurality of parameters by determining relationship between each of the plurality of parameters using a dependency Artificial Intelligence (AI)-based graph;
determine an eligibility of the analyzed plurality of parameters for prediction using at least one of a linear function and a multiple regression function based on the determined parameter dependency;
perform a plurality of parameter analysis on the plurality of parameters based on determined eligibility and the determined parameter dependency, wherein the plurality of parameter analysis comprises a feature importance analysis, a correlation analysis, partial dependency plots, a permutation importance analysis, and a feature selection analysis;
generate the appropriate Artificial Intelligence (AI)-based prediction model for prediction based on the performed plurality of parameter analysis; and
predict the performance of the at least one LLM based on the results of the generated appropriate Artificial Intelligence (AI)-based prediction model.

3. The system of claim 2, wherein to generate appropriate Artificial Intelligence (AI)-based prediction model for prediction based on the performed plurality of parameter analysis, the processor is configured to:
compute input design parameters comprised in the performance data;
determine an applicability of the linear function and the multiple regression function by analyzing the computed input design parameters;
perform one of a linear analysis and a multiple regression analysis on the computed input design parameters to generate prediction parameters based on determination;
compute interaction terms between the input design parameters based on the performed one of the linear analysis and the multiple regression analysis, wherein the interaction terms correspond to a statistical model representing a combined result of a two or more independent variables on a dependent variable;
perform interaction computations on the input design parameters based on the computed interaction terms, wherein the interaction computations comprise at least one of a logistic regression, an isotonic regression, and a Multivariate Adaptive Regression Splines (MARS); and
generate the appropriate Artificial Intelligence (AI)-based prediction model based on the prediction parameters and interaction computation results.

4. The system of claim 1, wherein the performance data associated with the at least one LLM comprises at least one of benchmark results from standardized Natural Language Processing (NLP) tasks, the performance metrics, a data on model size, training hyperparameters, and computational resources used.

5. The system of claim 1, wherein to extract the plurality of features related to the model performance from the received performance data, the processor is configured to:
preprocess the received performance data by performing at least one of a data normalization and a missing value detection; and
extract the plurality of features related to the model performance from the preprocessed performance data, wherein the plurality of features comprises at least one of model architecture details, a training dataset size and diversity, a training duration and computational resources, model complexity, training efficiency and hardware capabilities and hyperparameters used during training.

6. The system of claim 1, wherein to select appropriate Artificial Intelligence (AI)-based prediction model from among plurality of Artificial Intelligence (AI)-based prediction models based on the extracted plurality of features, the processor is configured to:
perform a feature importance analysis on the performance data to identify the plurality of features, wherein the feature importance analysis comprises at least one of decision trees technique, random forests technique, and a gradient boosting technique and wherein feature importance analysis is performed by using a permutation importance by shuffling values of the plurality of features to assess respective importance and indicating a parameter dependency;
perform a correlation analysis on the performance data to identify relationships between the plurality of features, wherein the correlation analysis computes correlation coefficients, selected from one of a Pearson, Spearman, or Kendall technique to quantify a strength of the relationships and wherein the correlation analysis identifies parameter dependencies as one of a positive, a negative, and a no relationship value based on the correlation coefficients;
detect parameter dependencies between the plurality of features based on results of the correlation analysis, wherein the parameter dependencies are visualized using one of partial dependency plots (PDP), an interpreted using Shapley values and Shapley Additive ExPlanations (SHAP) for assessing a contribution of each feature to the prediction; and
select the appropriate Artificial Intelligence (AI)-based prediction model from among the plurality of Artificial Intelligence (AI)-based prediction models based on the detected parameter dependencies and a nature of the performance data, wherein the appropriate Artificial Intelligence (AI)-based prediction model is selected from the plurality of Artificial Intelligence (AI)-based prediction models optimized for a plurality of types of data, comprising at least one of interaction-based fits, non-linear data fits, and monotonic relations.

7. The system of claim 6, wherein to select appropriate Artificial Intelligence (AI)-based prediction model from among plurality of Artificial Intelligence (AI)-based prediction models based on the detected parameter dependencies and the nature of the performance data, the processor is configured to:
select an interaction appropriate-fit model as the appropriate Artificial Intelligence (AI)-based prediction model in response to determining that the performance data indicates exceed an interaction level between the plurality of features;
select a Multivariate Adaptive Regression Splines (MARS) appropriate-fit model as the appropriate Artificial Intelligence (AI)-based prediction model in response to detecting non-linear data fits in the performance data;
select a polynomial appropriate-fit model as the appropriate Artificial Intelligence (AI)-based prediction model in response to detecting a presence of a non-linear relationship between the plurality of features; and
select an isotonic appropriate-fit model as the appropriate Artificial Intelligence (AI)-based prediction model in response to detecting a monotonic relationship between the plurality of features.

8. The system of claim 1, wherein to validate the predicted performance of the at least one LLM with actual performance metrics, the processor is configured to:
compare the predicted performance of the at least one LLM with a ground truth data;
compute at least one actual performance metric based one comparison, wherein the actual performance metric comprises at least one of an accuracy score, a precision value, a recall value, a perplexity score, a BiLingual Evaluation Understudy (BLEU) Score, and a Recall-Oriented Understudy for Gisting Evaluation (ROUGE) Score;
determine a performance level of the at least one LLM based on the computed at least one actual performance metric; and
validate the predicted performance of the at least one LLM based on the determined performance level.

9. The system of claim 1, wherein to fine tune the at least one LLM based on the predicted performance, the determined at least one issue and the identified resolution, the processor is configured to:
evaluate a plurality of relationships between the extracted plurality of features using a relation graph-based dynamic modeling technique;
determine a model complexity, a data size, a domain knowledge, and residual graph characteristics associated with the extracted plurality of features based on the evaluated plurality of relationships;
determine an appropriate modeling approach for predicting the performance of the at least one LLM based on the determined model complexity, the data size, the domain knowledge, and the residual graph characteristics using a decision graph, wherein the decision graph determines the appropriate modeling approach to be one of a polynomial model and an interaction-based model and wherein the polynomial model is selected in response to determining that residuals display a curve indicating a non-linearity, dataset size is large, and a domain knowledge indicates a polynomial fit and wherein the interaction-based model is selected in response to determining complex relationship levels between the plurality of features, and unusual residual patterns; compute a model fit score for selected model by assessing the performance of the at least one LLM; and
fine-tune the at least one LLM based on the computed model fit score and a domain hypothesis.

10. A method comprising:
receiving, by a processor, a performance data associated with at least one Large Language Model (LLM) from a plurality of data sources;
extracting, by the processor, a plurality of features related to a model performance from the received performance data;
selecting, by the processor, an appropriate Artificial Intelligence (AI)-based prediction model from among a plurality of Artificial Intelligence (AI)-based prediction models based on the extracted plurality of features;
applying, by the processor, the extracted plurality of features and the received performance data to selected appropriate Artificial Intelligence (AI)-based prediction model;
predicting, by the processor, a performance of the at least one LLM based on results of appropriate Artificial Intelligence (AI)-based prediction model;
validating, by the processor, the predicted performance of the at least one LLM with actual performance metrics;
determining, by the processor, at least one issue in a model performance based on results of validation, wherein the at least one issue indicates a performance gap in the at least one LLM;
identifying, by the processor, a resolution for rectifying the determined at least one issue based on pre-stored rules;
fine tuning, by the processor, the at least one LLM based on the predicted performance, the determined at least one issue and the identified resolution; and
outputting, by the processor, fine-tuned at least one LLM on a user interface of a user device.

11. The method of claim 10, wherein predicting the performance of the at least one LLM based on the results of appropriate Artificial Intelligence (AI)-based prediction model comprises:
analyzing, by the processor, a plurality of parameters comprised in the performance data to identify at least one of dependent variables and independent variables, wherein the plurality of parameters corresponds to input design parameters;
determining, by the processor, a parameter dependency for each of the plurality of parameters by determining relationship between each of the plurality of parameters using a dependency Artificial Intelligence (AI)-based graph;
determining, by the processor, an eligibility of the analyzed plurality of parameters for prediction using at least one of a linear function and a multiple regression function based on determined parameter dependency;
performing, by the processor, a plurality of parameter analysis on the plurality of parameters based on the determined eligibility and the determined parameter dependency, wherein the plurality of parameter analysis comprises a feature importance analysis, a correlation analysis, partial dependency plots, a permutation importance analysis, and a feature selection analysis;
generating, by the processor, the appropriate Artificial Intelligence (AI)-based prediction model for prediction based on the performed plurality of parameter analysis; and
predicting, by the processor, the performance of the at least one LLM based on the results of generated appropriate Artificial Intelligence (AI)-based prediction model.

12. The method of claim 11, wherein generating appropriate Artificial Intelligence (AI)-based prediction model for prediction based on performed plurality of parameter analysis comprises:
computing, by the processor, the input design parameters comprised in the performance data;
determining, by the processor, an applicability of the linear function and the multiple regression function by analyzing computed input design parameters;
performing, by the processor, one of a linear analysis and a multiple regression analysis on the computed input design parameters to generate prediction parameters based on the determination;
computing, by the processor, interaction terms between the input design parameters based on the performed one of the linear analysis and the multiple regression analysis, wherein the interaction terms corresponds to a statistical model representing a combined result of a two or more independent variables on a dependent variable;
performing, by the processor, interaction computations on the input design parameters based on computed interaction terms, wherein the interaction computations comprise at least one of a logistic regression, an isotonic regression, and a Multivariate Adaptive Regression Splines (MARS); and
generating, by the processor, the appropriate Artificial Intelligence (AI)-based prediction model based on the prediction parameters and interaction computation results.

13. The method of claim 10, wherein the performance data associated with the at least one LLM comprises at least one of benchmark results from standardized Natural Language Processing (NLP) tasks, performance metrics, a data on model size, training hyperparameters, and computational resources used.

14. The method of claim 10, wherein extracting the plurality of features related to the model performance from received performance data comprises:
preprocessing, by the processor, the received performance data by performing at least one of a data normalization and a missing value detection; and
extracting, by the processor, the plurality of features related to the model performance from preprocessed performance data, wherein the plurality of features comprises at least one of model architecture details, a training dataset size and diversity, a training duration and computational resources, model complexity, training efficiency and hardware capabilities and hyperparameters used during training.

15. The method of claim 10, wherein selecting appropriate Artificial Intelligence (AI)-based prediction model from among plurality of Artificial Intelligence (AI)-based prediction models based on extracted plurality of features comprise:
performing, by the processor, a feature importance analysis on the performance data to identify the plurality of features, wherein the feature importance analysis comprises at least one of decision trees technique, random forests technique, and a gradient boosting technique and wherein feature importance analysis is performed by using a permutation importance by shuffling values of the plurality of features to assess respective importance and indicating a parameter dependency;
performing, by the processor, a correlation analysis on the performance data to identify relationships between the plurality of features, wherein the correlation analysis computes correlation coefficients, selected from one of a Pearson, Spearman, or Kendall technique to quantify a strength of the relationships and wherein the correlation analysis identifies parameter dependencies as one of a positive, a negative, and a no relationship value based on the correlation coefficients;
detecting, by the processor, parameter dependencies between the plurality of features based on results of the correlation analysis, wherein the parameter dependencies are visualized using one of partial dependency plots (PDP), an interpreted using Shapley values and Shapley Additive ExPlanations (SHAP) for assessing a contribution of each feature to the prediction; and
selecting, by the processor, the appropriate Artificial Intelligence (AI)-based prediction model from among the plurality of Artificial Intelligence (AI)-based prediction models based on the detected parameter dependencies and a nature of the performance data, wherein the appropriate Artificial Intelligence (AI)-based prediction model is selected from the plurality of Artificial Intelligence (AI)-based prediction models optimized for a plurality of types of data, comprising at least one of interaction-based fits, non-linear data fits, and monotonic relations.

16. The method of claim 15, wherein selecting appropriate Artificial Intelligence (AI)-based prediction model from among plurality of Artificial Intelligence (AI)-based prediction models based on detected parameter dependencies and the nature of the performance data comprises:
selecting, by the processor, an interaction appropriate-fit model as the appropriate Artificial Intelligence (AI)-based prediction model in response to determining that the performance data indicates exceed an interaction level between the plurality of features;
selecting, by the processor, a Multivariate Adaptive Regression Splines (MARS) appropriate-fit model as the appropriate Artificial Intelligence (AI)-based prediction model in response to detecting non-linear data fits in the performance data;
selecting, by the processor, a polynomial appropriate-fit model as the appropriate Artificial Intelligence (AI)-based prediction model in response to detecting a presence of a non-linear relationship between the plurality of features; and
selecting, by the processor, an isotonic appropriate-fit model as the appropriate Artificial Intelligence (AI)-based prediction model in response to detecting a monotonic relationship between the plurality of features.

17. The method of claim 10, wherein validating predicted performance of the at least one LLM with actual performance metrics comprise:
comparing, by the processor, the predicted performance of the at least one LLM with a ground truth data;
computing, by the processor, at least one actual performance metric based on comparison, wherein the actual performance metric comprises at least one of an accuracy score, a precision value, a recall value, a perplexity score, a BLEU Score, and a ROUGE Score;
determining, by the processor, a performance level of the at least one LLM based on computed at least one actual performance metric; and
validating, by the processor, the predicted performance of the at least one LLM based on determined performance level.

18. The method of claim 10, wherein fine tuning the at least one LLM based on predicted performance, determined at least one issue and identified resolution comprises:
evaluating, by the processor, a plurality of relationships between extracted plurality of features using a relation graph-based dynamic modeling technique;
determining, by the processor, a model complexity, a data size, a domain knowledge, and residual graph characteristics associated with the extracted plurality of features based on the evaluated plurality of relationships;
determining, by the processor, an appropriate modeling approach for predicting the performance of the at least one LLM based on the determined model complexity, the data size, the domain knowledge, and the residual graph characteristics using a decision graph, wherein the decision graph determines the appropriate modeling approach to be one of a polynomial model and an interaction-based model and wherein the polynomial model is selected in response to determining that residuals display a curve indicating a non-linearity, dataset size is large, and a domain knowledge indicates a polynomial fit and wherein the interaction-based model is selected in response to determining complex relationship levels between the plurality of features, and unusual residual patterns;
compute a model fit score for selected model by assessing the performance of the at least one LLM; and
fine-tuning, by the processor, the at least one LLM based on the computed model fit score and a domain hypothesis.

19. A non-transitory computer readable medium comprising a processor-executable instructions that cause a processor to:
receive a performance data associated with at least one Large Language Model (LLM) from a plurality of data sources;
extract a plurality of features related to a model performance from the received performance data;
select an appropriate Artificial Intelligence (AI)-based prediction model from among a plurality of Artificial Intelligence (AI)-based prediction models based on the extracted plurality of features;
apply the extracted plurality of features and the received performance data to selected appropriate Artificial Intelligence (AI)-based prediction model;
predict a performance of the at least one LLM based on results of appropriate Artificial Intelligence (AI)-based prediction model;
validate the predicted performance of the at least one LLM with actual performance metrics;
determine at least one issue in a model performance based on results of validation, wherein the at least one issue indicates a performance gap in the at least one LLM;
identify a resolution for rectifying the determined at least one issue based on pre-stored rules;
fine tune the at least one LLM based on the predicted performance, the determined at least one issue and the identified resolution; and
output fine-tuned at least one LLM on a user interface of a user device.

20. The non-transitory computer readable medium of claim 19, wherein to predict the performance of the at least one LLM based on the results of appropriate Artificial Intelligence (AI)-based prediction model, the processor-executable instructions cause the processor to:
analyze a plurality of parameters comprised in the performance data to identify at least one of dependent variables and independent variables, wherein the plurality of parameters corresponds to input design parameters;
determine a parameter dependency for each of the plurality of parameters by determining relationship between each of the plurality of parameters using a dependency Artificial Intelligence (AI)-based graph;
determine an eligibility of the analyzed plurality of parameters for prediction using at least one of a linear function and a multiple regression function based on the determined parameter dependency;
perform a plurality of parameter analysis on the plurality of parameters based on the determined eligibility and the determined parameter dependency, wherein the plurality of parameter analysis comprises a feature importance analysis, a correlation analysis, partial dependency plots, a permutation importance analysis, and a feature selection analysis;
generate the appropriate Artificial Intelligence (AI)-based prediction model for prediction based on the performed plurality of parameter analysis; and
predict the performance of the at least one LLM based on the results of generated appropriate Artificial Intelligence (AI)-based prediction model.
